(19) United States
(12) Patent Application Publication
(10) Pub. No.: US 2024/0320515 A1
(43) Pub. Date: Sep. 26, 2024

(54) LOCATION INTELLIGENCE MANAGEMENT SYSTEM AND METHOD

(71) Applicant: South Tejas Solutions, LLC, Spring, TX (US)

(72) Inventors: Olivia Quesada, Spring, TX (US); Demetrius Quesada, Spring, TX (US)

(21) Appl. No.: 18/598,858

(22) Filed: Mar. 7, 2024

Related U.S. Application Data
(60) Provisional application No. 63/453,252, filed on Mar. 20, 2023.

(51) Int. Cl. G06N 5/01

(52) U.S. Cl. CPC G06N 5/01

(57) ABSTRACT

A computer-implemented method of providing location intelligence for a geospatial location, comprising: receiving, from a plurality of location intelligence sources, a plurality of location intelligence data about the geospatial location, wherein the plurality of location intelligence data are not natively interoperable with one another; operating a machine learning (ML) algorithm to reconcile plurality of location intelligence data into a location intelligence digest for the geospatial location; and presenting the location intelligence digest to a human user in a human perceptible form via a human interface device (HID).

### CROSS REFERENCE TO RELATED APPLICATION

This application claims priority to U.S. Provisional Application No. 63/453,252, filed 20 Mar. 2023, titled “Location Intelligence Enterprise Management System,” which is incorporated herein by reference.

### Field of the Specification

This application relates in general to geographic information system, and more particularly though not exclusively to a location intelligence management system and method.

### BACKGROUND

Geographic Information Systems (GIS) include large databases of geographic coordinates, with associated points of interest. GIS can be used to visualize location data in many contexts.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram illustration of selected elements of a location intelligence ecosystem.

FIG. 2 is a block diagram illustration of selected elements of a location intelligence operational ecosystem.

FIG. 3 is a block diagram of selected elements of a location intelligence orchestrator.

FIG. 4 is a flow chart illustrating selected elements of a location intelligence system lifecycle.

FIGS. 5a and 5b provide a flow chart illustrating selected elements of a title company work flow.

FIG. 6 is a block diagram illustration of selected elements of a real estate intelligence ecosystem.

FIGS. 7a-7c provide a flow chart illustrating selected elements of a real estate intelligence method.

FIGS. 8a and 8b provide a flow chart illustrating selected elements of a real estate agent method.

FIG. 9 is a block diagram of selected elements of a hardware platform.

FIG. 10 is a block diagram of selected elements of a network function virtualization (NFV) infrastructure.

FIG. 11 is a block diagram of selected elements of a containerization infrastructure.

FIG. 12 illustrates machine learning according to a “textbook” problem with real-world applications.

FIG. 13 is a flowchart of a method that may be used to train a neural network.

FIG. 14 is a flowchart of a method of using a neural network to classify an object.

FIG. 15 is a block diagram illustrating selected elements of an analyzer engine.

FIG. 16 is a block diagram illustration of selected elements of a clustering system.

### SUMMARY

A computer-implemented method of providing location intelligence for a geospatial location, comprising: receiving, from a plurality of location intelligence sources, a plurality of location intelligence data about the geospatial location, wherein the plurality of location intelligence data are not natively interoperable with one another; operating a machine learning (ML) algorithm to reconcile plurality of location intelligence data into a location intelligence digest for the geospatial location; and presenting the location intelligence digest to a human user in a human perceptible form via a human interface device (HID).

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

The present specification provides a location intelligence management system and method, including a location intelligence orchestrator. Location intelligence is a valuable tool for improving workflows and business performance. However, using existing infrastructure, management and analysis of geospatial data from different sources may be a challenge for some users. Aspects of the present specification provide a location intelligence orchestrator that centralizes, integrates, manages, and analyzes geospatial data. The location intelligence orchestrator may provide user insights based on diverse geospatial data sources. It may also provide services such as data visualization, predictive analytics, real-time data updates, collaboration tools, mobile optimization, social media integration, customizable workflows, language support, third-party application integration, and automated reporting by way of illustrative and nonlimiting example.

Location intelligence may provide valuable insight into key business assets such as performance, customer location, and operational optimization. However, managing and analyzing diverse geospatial data from different sources may be challenging. Because the location intelligence orchestrator of the present specification provides a centralized platform, entities may optimize operations by identifying the best locations for their activities, such as opening new stores, buying or selling real estate, building transportation, or other functions. The location intelligence orchestrator may provide a holistic view of operations, streamlined workflows, and the ability to respond quickly to changes in the market. Because the location intelligence orchestrator integrates multiple geospatial data into a single platform, businesses can streamline data management and analysis procedures, thus providing more informed decision-making. With location intelligence, businesses may derive insights from geospatial data, which can contribute to operational effectiveness. As used throughout the specification, geospatial data comprise data that include a location component. For example, geospatial data may include GPS coordinates of a particular asset such as a building, a vehicle, or a location. Geospatial data may integrate with large data sources such as geographic information systems (GIS), which may include mapping technology and databases of points of interest associated with geospatial coordinates.

### Selected Examples

The foregoing can be used to build or embody several example implementations, according to the teachings of the present specification. Some example implementations are included here as nonlimiting illustrations of these teachings.

There is disclosed in an example, a computer-implemented method of providing location intelligence for a geospatial location, comprising: receiving, from a plurality of location intelligence sources, a plurality of location intelligence data about the geospatial location, wherein the plurality of location intelligence data are not natively interoperable with one another; operating a machine learning (ML) algorithm to reconcile plurality of location intelligence data into a location intelligence digest for the geospatial location; and presenting the location intelligence digest to a human user in a human perceptible form via a human interface device (HID).

There is further disclosed an example, wherein the location intelligence sources comprise at least one geographic information system (GIS) database.

There is further disclosed an example, wherein the location intelligence sources comprise real-time sensors and/or internet of things (IoT) devices.

There is further disclosed an example, wherein the location intelligence sources comprise websites of businesses or enterprises with a physical presence near the geospatial location.

There is further disclosed an example, wherein the location intelligence sources comprise satellite imagery of the geospatial location and/or nearby locations.

There is further disclosed an example, wherein the location intelligence sources comprise third-party applications.

There is further disclosed an example, wherein the third-party applications comprises enterprise resource planning (ERP) or customer relationship management (CRM) systems.

There is further disclosed an example, wherein presenting the location intelligence digest to the human user via the HID comprises optimizing the HID for a mobile device.

There is further disclosed an example, wherein presenting the location intelligence digest to the human user via the HID comprises providing predictive analytics.

There is further disclosed an example, wherein presenting the location intelligence digest to the human user via the HID comprises providing collaboration tools for a plurality of users.

There is further disclosed an example, wherein presenting the location intelligence digest to the human user via the HID comprises providing an automatically generated report of the location intelligence digest.

There is further disclosed an example, wherein presenting the location intelligence digest to the human user via the HID comprises translating the location intelligence digest into a target language for the human user.

There is further disclosed an example, wherein presenting the location intelligence digest to the human user via the HID comprises providing the location intelligence digest as a contextual input to a chatbot, and providing an interface for the human user to interact with the chatbot.

There is further disclosed an example, wherein presenting the location intelligence digest to the human user via the HID comprises providing a user-customizable workflow display.

There is further disclosed an example, further comprising providing a private cloud environment for private information specific to the human user or an enterprise that the human user is associated with, wherein the private cloud environment encrypts the private information.

There is further disclosed an example, wherein the human user or the enterprise own decryption keys for the private information.

There is further disclosed an example, wherein the human user or the enterprise own decryption keys for the private information, exclusive of an operator of a location intelligence orchestrator that hosts the private information.

There is further disclosed an example, wherein the HID comprises a map overlay.

There is further disclosed an example of an apparatus comprising means for performing the method.

There is further disclosed an example, wherein the means for performing the method comprise a processor and a memory.

There is further disclosed an example, wherein the memory comprises machine-readable instructions that, when executed, cause the apparatus to perform the method.

There is further disclosed an example, wherein the apparatus is a computing system.

There is further disclosed an example of at least one computer readable medium comprising instructions that, when executed, implement a method or realize an apparatus as described.

There is further disclosed an example of one or more tangible, nontransitory computer-readable storage media having stored thereon executable instructions to provide a location intelligence orchestrator, the instructions to instruct a processor to: receive, from a plurality of location intelligence sources, a plurality of location intelligence data about a geospatial location, wherein the plurality of location intelligence data are not natively interoperable with one another; operate a machine learning (ML) algorithm to reconcile plurality of location intelligence data into a location intelligence digest for the geospatial location; and present the location intelligence digest to a human user in a human perceptible form via a human interface device (HID).

There is further disclosed an example, wherein the location intelligence sources comprise at least one geographic information system (GIS) database.

There is further disclosed an example, wherein the location intelligence sources comprise real-time sensors and/or internet of things (IoT) devices.

There is further disclosed an example, wherein the location intelligence sources comprise websites of businesses or enterprises with a physical presence near the geospatial location.

There is further disclosed an example, wherein the location intelligence sources comprise satellite imagery of the geospatial location and/or nearby locations.

There is further disclosed an example, wherein the location intelligence sources comprise third-party applications.

There is further disclosed an example, wherein the third-party applications comprises enterprise resource planning (ERP) or customer relationship management (CRM) systems.

There is further disclosed an example, wherein presenting the location intelligence digest to the human user via the HID comprises optimizing the HID for a mobile device.

There is further disclosed an example, wherein presenting the location intelligence digest to the human user via the HID comprises providing predictive analytics.

There is further disclosed an example, wherein presenting the location intelligence digest to the human user via the HID comprises providing collaboration tools for a plurality of users.

There is further disclosed an example, wherein presenting the location intelligence digest to the human user via the HID comprises providing an automatically generated report of the location intelligence digest.

There is further disclosed an example, wherein presenting the location intelligence digest to the human user via the HID comprises translating the location intelligence digest into a target language for the human user.

There is further disclosed an example, wherein presenting the location intelligence digest to the human user via the HID comprises providing the location intelligence digest as a contextual input to a chatbot, and providing an interface for the human user to interact with the chatbot.

There is further disclosed an example, wherein presenting the location intelligence digest to the human user via the HID comprises providing a user-customizable workflow display.

There is further disclosed an example, wherein the instructions are further to provide a private cloud environment for private information specific to the human user or an enterprise that the human user is associated with, wherein the private cloud environment encrypts the private information.

There is further disclosed an example, wherein the human user or the enterprise own decryption keys for the private information.

There is further disclosed an example, wherein the human user or the enterprise own decryption keys for the private information, exclusive of an operator of a location intelligence orchestrator that hosts the private information.

There is further disclosed an example, wherein the HID comprises a map overlay.

There is further disclosed an example of a location intelligence orchestrator, comprising: a hardware platform comprising at least one processor circuit and at least one memory; and instructions encoded within the at least one memory to instruct the at least one processor circuit to: receive, from a plurality of location intelligence sources, a plurality of location intelligence data about a geospatial location, wherein the plurality of location intelligence data are not natively interoperable with one another; operate a machine learning (ML) algorithm to reconcile plurality of location intelligence data into a location intelligence digest for the geospatial location; and present the location intelligence digest to a human user in a human perceptible form via a human interface device (HID).

There is further disclosed an example, wherein the location intelligence sources comprise at least one geographic information system (GIS) database.

There is further disclosed an example, wherein the location intelligence sources comprise real-time sensors and/or internet of things (IoT) devices.

There is further disclosed an example, wherein the location intelligence sources comprise websites of businesses or enterprises with a physical presence near the geospatial location.

There is further disclosed an example, wherein the location intelligence sources comprise satellite imagery of the geospatial location and/or nearby locations.

There is further disclosed an example, wherein the location intelligence sources comprise third-party applications.

There is further disclosed an example, wherein the third-party applications comprises enterprise resource planning (ERP) or customer relationship management (CRM) systems.

There is further disclosed an example, wherein presenting the location intelligence digest to the human user via the HID comprises optimizing the HID for a mobile device.

There is further disclosed an example, wherein presenting the location intelligence digest to the human user via the HID comprises providing predictive analytics.

There is further disclosed an example, wherein presenting the location intelligence digest to the human user via the HID comprises providing collaboration tools for a plurality of users.

There is further disclosed an example, wherein presenting the location intelligence digest to the human user via the HID comprises providing an automatically generated report of the location intelligence digest.

There is further disclosed an example, wherein presenting the location intelligence digest to the human user via the HID comprises translating the location intelligence digest into a target language for the human user.

There is further disclosed an example, wherein presenting the location intelligence digest to the human user via the HID comprises providing the location intelligence digest as a contextual input to a chatbot, and providing an interface for the human user to interact with the chatbot.

There is further disclosed an example, wherein presenting the location intelligence digest to the human user via the HID comprises providing a user-customizable workflow display.

There is further disclosed an example, wherein the instructions are further to provide a private cloud environment for private information specific to the human user or an enterprise that the human user is associated with, wherein the private cloud environment encrypts the private information.

There is further disclosed an example, wherein the human user or the enterprise own decryption keys for the private information.

There is further disclosed an example, wherein the human user or the enterprise own decryption keys for the private information, exclusive of an operator of a location intelligence orchestrator that hosts the private information.

There is further disclosed an example, wherein the HID comprises a map overlay.

### DETAILED DESCRIPTION OF THE DRAWINGS

A system and method for location intelligence management will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

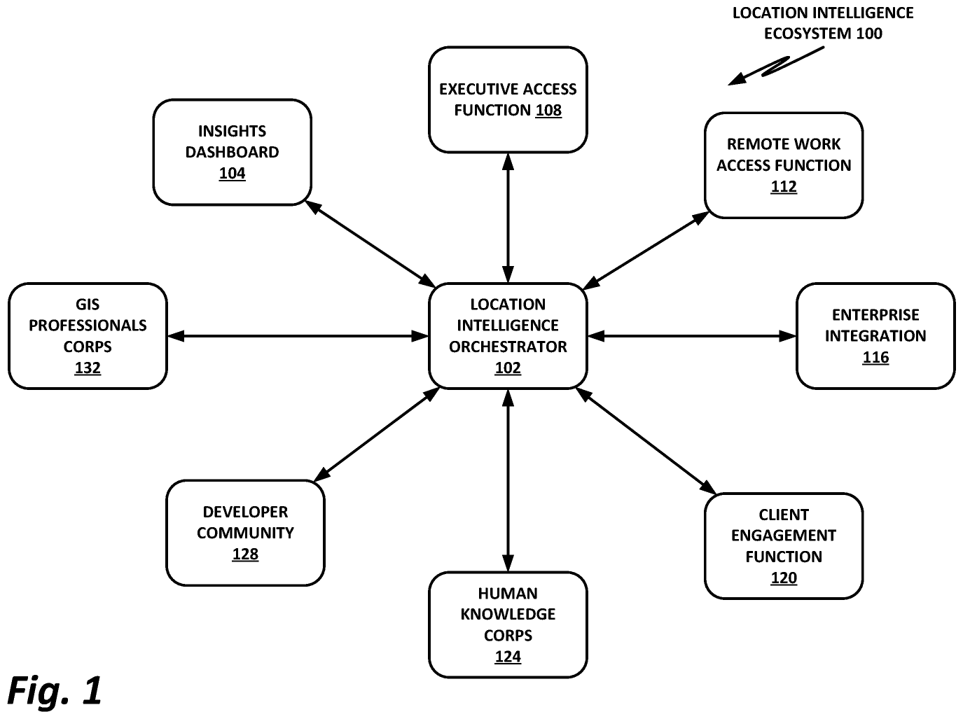

FIG. 1 is a block diagram illustration of a location intelligence ecosystem 100. Location intelligence ecosystem 100 includes a location intelligence orchestrator 102. Location intelligence orchestrator 102 may be, for example, software as a service (SaaS), a cloud-based service, or other network service. Location intelligence orchestrator 102 may include business to business (B2B) logic, enterprise resource management (ERM) plug-ins, and other information management functions.

Location intelligence orchestrator 102 may interact with and provide various functions. For example, executive access functions 108 may be provided so that executive-level personnel may access location intelligence data relevant to their job functions.

Remote work access function 112 may enable work-from-anywhere or remote workers of an enterprise to access location intelligence data relevant to their job functions.

Enterprise integration 116 may include B2B, ERM, CRM, and other data management plug-ins that consume location intelligence, such as GIS data from disparate sources, and transform those data into a format that is usable by an enterprise with minimal manual intervention.

Client engagement function 120 may provide resources to clients of an enterprise that enable them to access valuable and convenient location intelligence data. For example, if clients of an airline want more information about destination cities that the airline flies to, client engagement function 120 may collate GIS data from various sources and present a comprehensive view to the client.

Human knowledge corps 124 may include knowledge professionals who can provide input and feedback to a location intelligence system to improve the system over time.

Developer community 128 includes hardware, software, and/or firmware developers to create software and devices that access and benefit from location intelligence data.

GIS professionals corps 132 may include human professionals with background in GIS data, whose expertise can help to maintain and improve the system.

Insights dashboard 104 may include a software dashboard provided, for example, by a web interface into location intelligence orchestrator 102, which provides key insights into important business processes.

Location intelligence orchestrator 102 provides a centralized platform for businesses to manage and analyze geospatial data from various sources. Orchestrator 102 may be designed to be accessible via desktop, laptop, and-or mobile devices, and can also be deployed in the cloud. In some cases, a local version of location intelligence orchestrator 102 may run on an individual user's device. Orchestrator 102 may include advanced geospatial artificial intelligence (AI) and machine learning (ML) algorithms, which provide insights based on diverse data sources.

In illustrated examples, the orchestrator provides data visualization tools that allow users to display data in different formats, including charts, graphs, and heat maps by way of illustrative and nonlimiting example. The location intelligence orchestrator may also use advanced geospatial AI and ML algorithms, for example to gather location intelligence data from a plurality of incompatible or sources, which sources may include data that are not natively interoperable with one another. The AI/ML algorithms may digest these disparate data and combine them or reconcile them into a location intelligence digest for a given geospatial location. The location intelligence digest may include information such as local population density, home price trends, inflation data, traffic patterns, neighborhood school information, neighborhood church information, local customs, purchasing habits, or other information. While these data may be valuable individually, as a digest they may provide a synergy wherein the digest is more valuable than the sum of its parts. The digest may be presented to a human user via a human interface device (HID), such as a monitor, audio readout, or other. In one illustrative example, a map overlay is provided wherein a geospatial location is illustrated, and the digest is presented as an automated report providing various data of interest about the geospatial location. In another illustrative example, the HID may include a chatbot that a human user can interact with. The data may be provided to the chatbot as contextual information about the geospatial location, and the human user can then create queries, such as “What are the schools like in this neighborhood?” The orchestrator may instruct the chatbot to use the geolocation intelligence digest as a source for its answer, and the chatbot may then conversationally disclose to the human user what the schools are like in the selected area.

The location intelligence orchestrator may also provide services such as predictive analytics, which enables users to forecast trends, identify potential risks, and make informed decisions.

Advantageously, the orchestrator may integrate with data sources that include sensors and IoT devices to provide real-time data updates, which can allow businesses to respond quickly to changes in their environment. For example, a location intelligence orchestrator 102 may integrate with a weather station as one of its data sources. Thus the location intelligence digest for a location may include a real-time weather update, which can be used to make real-time decisions.

Location intelligence orchestrator 102 may also include collaboration tools that enable users to work together on projects, share data, and communicate in real time.

In selected embodiments, location intelligence orchestrator 102 may provide displays or interfaces that are optimized for mobile devices, allowing users to access the system via mobile devices from any location where a network connection is available.

Embodiments of orchestrator 102 may also provide social media integration to allow businesses to analyze location-based data from social media channels. Thus, in one illustrative example, social media posts or other social media data may form one of the disparate data sources that inform a location intelligence digest.

As an additional supplemental data source, orchestrator 102 may include a web crawler, which may scrape websites of businesses, schools, churches, or other entities with a physical presence near the geospatial location of interest. An ML model, such as an NLP model, may analyze these websites for content, and may integrate the data into a location intelligence digest.

In illustrative embodiments, location intelligence orchestrator 102 may also provide automated reporting based on predefined templates. These predefined templates may reduce errors and save time for the enterprise accessing the location intelligence digest.

To preserve user privacy, orchestrator 102 may provide a secure private cloud environment, and in particular may store any user or enterprise private or proprietary data within the secure cloud environment. The secure private environment may encrypt the secured private data, and the decryption keys may be owned by the user, or by an enterprise that the user is associated with. Depending on preferences and the needs of a particular embodiment, the orchestrator may retain backups of those decryption keys for the users, so that the data are still accessible if the decryption keys are lost. Alternatively, in cases where users prefer higher privacy over data accessibility, the user or the enterprise may own the decryption keys to the exclusion of the operator of the orchestrator. In that case, even the orchestrator may have no commercially reasonable means of decrypting the data absent the keys from the user or enterprise.

In securing user data, orchestrator 102 may use up-to-date security technologies and protocols, including data encryption and access controls, to ensure confidentiality and integrity of client data.

Clients may set up user permissions and access levels to restrict access to specific data and services. In particular, orchestrator 102 may be designed to comply with relevant industry standards and regulations.

A vendor or operator of orchestrator 102 may offer training and support options, including training and resources, on-site training, and dedicated support staff. In embodiments, clients may receive ongoing support and updates to ensure that they receive the most recent and reliable version of the orchestrator. This may also allow the operator to respond to issues or concerns quickly and effectively. Using orchestrator 102, clients may be able to make informed decisions, track apps track assets, and optimize processes. Orchestrator 102 provides a centralized platform to access location-based data and services and workflows, and improve decision-making ability.

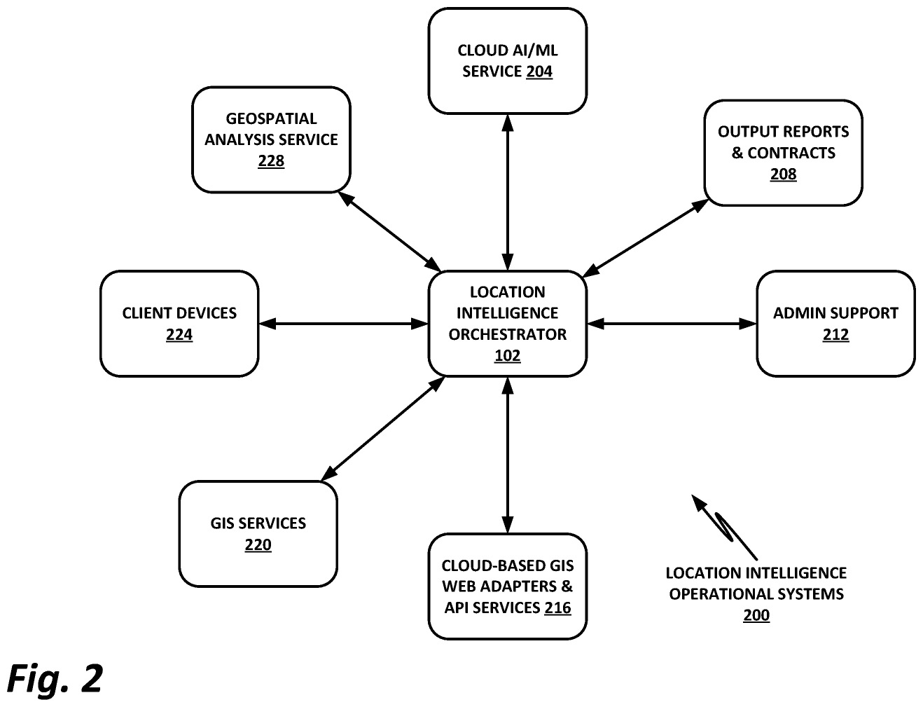

FIG. 2 is a block diagram of selected elements of the location intelligence operational system ecosystem. Location intelligence operational systems 200 include various support functions for location intelligence orchestrator 102. These may include by way of illustrative and nonlimiting example, an administrative support function 212, output reports and contracts 208, a localized or cloud-based AI or ML service 204, a geospatial analysis service 228, interfaces for client devices 224, GIS services 220, and cloud-based GIS web adapters and API services 216.

GIS tools may be used to analyze and visualize spatial data, such as population density, land use, transportation networks, or similar. GIS tools may also be used to identify patterns and trends and make informed decisions.

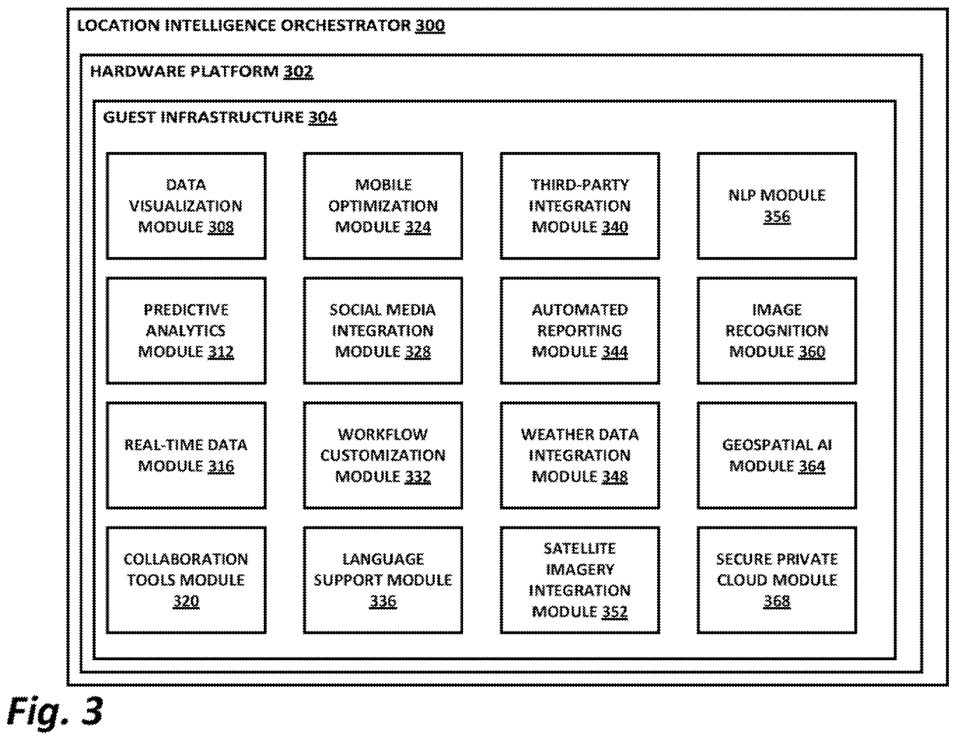

FIG. 3 is a block diagram illustration of selected elements of a location intelligence orchestrator 300, which may be for example an instance of location intelligence orchestrator 102 of FIG. 1, or a similar location intelligence orchestrator.

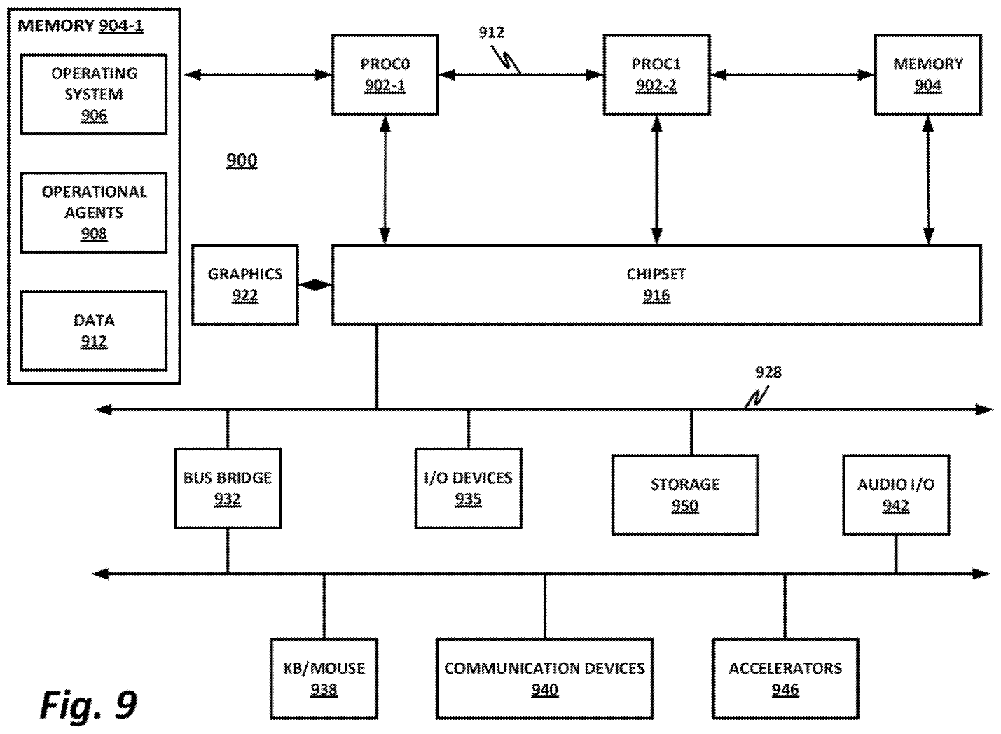

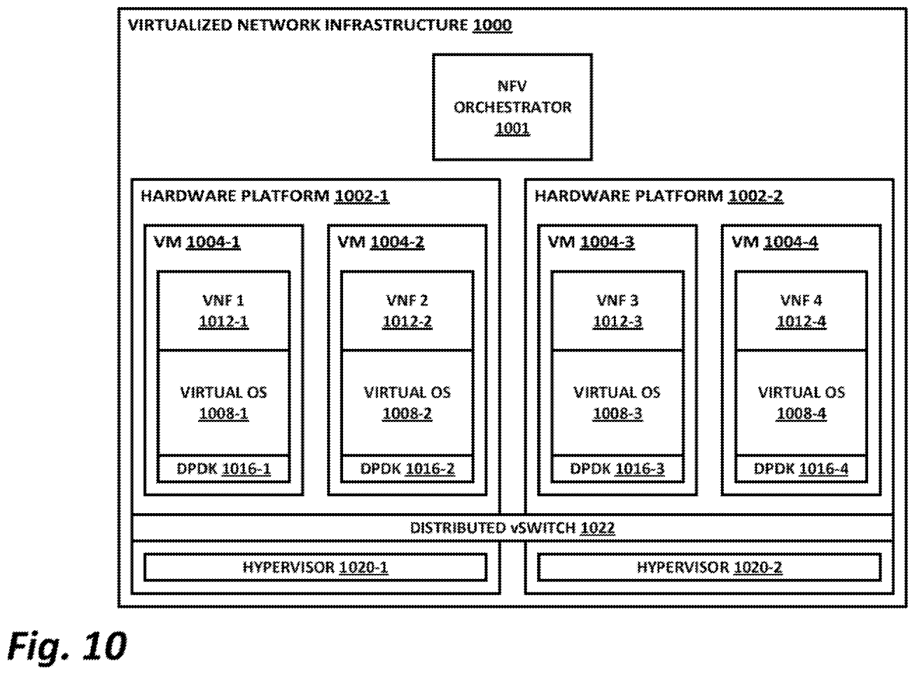

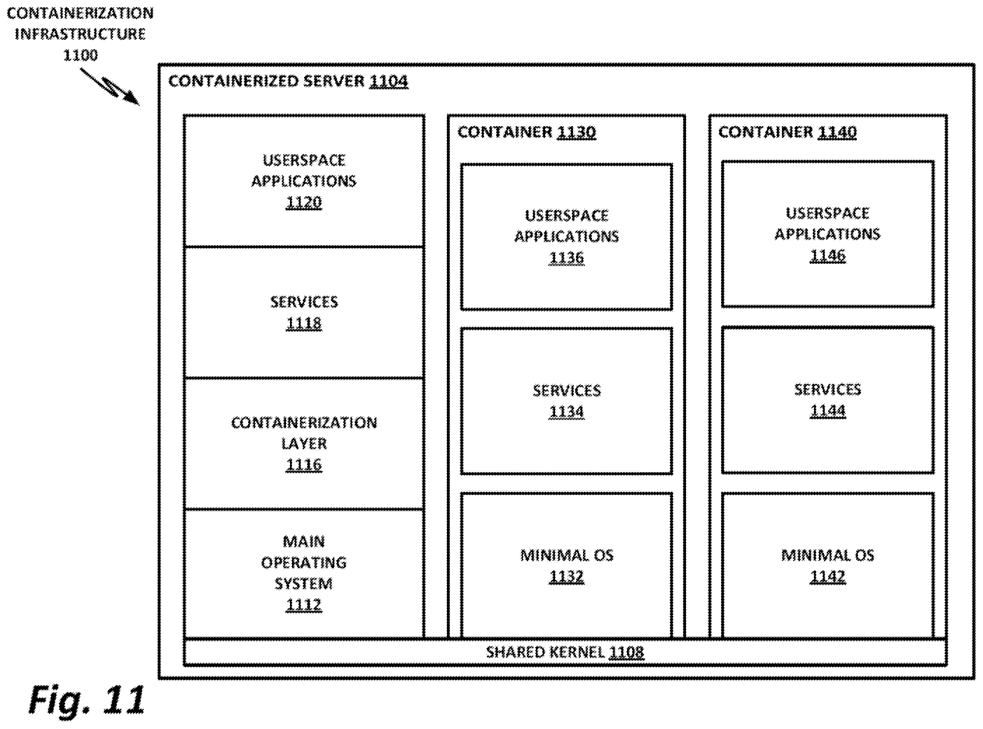

Location intelligence orchestrator 300 is based on a hardware platform 302, as illustrated in FIG. 9 below. Orchestrator 300 may also provide a guest infrastructure 304, which may provide, for example, virtualization as illustrated in FIG. 10 below, and/or containerization as illustrated in FIG. 11 below.

Location intelligence orchestrator 300 may provide a customizable user interface to various devices such as mobile, desktop, tablets, smart watches, and others. This may allow users to tailor the system to specific needs.

Orchestrator 300 may also provide multiple deployment options. For example, orchestrator 300 may be deployed on premises, in a cloud environment, or in a hybrid deployment. This may provide businesses with the flexibility to choose how to implement the system and may ensure that businesses can select the deployment option that best suits their needs.

Location intelligence orchestrator 300 may provide a number of industry-specific solutions in many different sectors. This may include retail, logistics, transportation, agriculture, real estate, oil and gas, insurance, and government, by way of illustrative and nonlimiting example. In this specification, an application is illustrated for the real estate industry including use by title companies. This illustration should be understood to be nonlimiting.

Location intelligence orchestrator 300 may also be highly scalable. This may allow businesses to expand their use of the system as their needs evolve. Scalability may be realized, for example, by using virtualization and are containerization to allocate resources on an as-needed basis.

Hosted within guest infrastructure 304 are various software modules. These software modules may be virtual machines, containers, microservices, dedicated servers, or native software programs. They may include, for example, instructions stored on one or more computer-readable storage media, including instructions to instruct a processor circuit to perform various methods. The division of functions into modules in this illustration does not imply an exclusive or mandatory division. For example, in the modules illustrated below, two or more modules may be included within a single program, virtual machine, container, or other entity. Furthermore, any of the modules illustrated below may be divided into a plurality of virtual machines, containers, micro services, physical servers, software modules, or other. Any combination of the foregoing are also possible.

Data visualization module 308 provides interactive and customizable data visualization tools, and may allow users to display data in different formats. Illustrative formats include charts, graphs, heat maps, images, and overlays. Data visualization enables users to gain deeper insights into their data, and to make more informed decisions.

Predictive analytics module 312 may leverage AI and ML capabilities to provide predictive analytics, thus enabling users to forecast trends, make predictions, and identify potential risks or opportunities. Predictive analytics may enable businesses to be more proactive and to stay ahead of their competition.

Real-time data module 316 may integrate sensors, IoT devices, real-time news, and other real-time sources of information to provide real-time updates to a location intelligence digest. These real-time data may allow users to react quickly to changes in the environment. This may be useful, for example, in industries such as logistics and transportation, where real-time data may be valuable in optimizing operations.

Collaboration tools module 320 may provide collaboration tools to enable users to work together on projects, share data, and communicate in real-time. Collaboration may be useful for geographically dispersed teams, such as teams that work from home or that work remotely, and that need to work together on location-based projects.

Mobile optimization module 324 may optimize software displays and communication for mobile devices. This mobile optimization may enable users to access the system from anywhere or anytime, so long as they have mobile network access. Mobile access may be useful for field workers, for example, who need to collect data and update information in real-time.

Social media integration module 328 may integrate with social media platforms, thus allowing businesses to analyze location-based data from social media channels. Social media integration may enable businesses to gain insight into customer behavior preferences, and allow businesses create more targeted marketing campaigns. Social media integration may also enable businesses to monitor social trends, and to predict market direction.

Workflow customization module 332 may provide customizable workflows that allow users to tailor the system to their specific needs. Customized workflows may enable businesses to create workflows that align with their existing processes and procedures, thus enabling location intelligence orchestrator 300 to integrate with legacy systems and processes.

Language support module 336 may provide support for multiple languages, including machine-assisted translation. This may enable users to access the system in their native language, and to view a location intelligence digest in their native language. Many data sources may be available only in one language, and thus language support module 336 may make these data available to users in a different language via machine translation. This may be useful especially for businesses or enterprises that operate in multiple countries and regions.

Third-party integration module 340 may integrate orchestrator 300 with third-party applications, such as ERP, CRM, accounting systems, legacy software, and external data sources. This integration may allow users to access information from one centralized platform, rather than having to hunt down information on various platforms.

Automated reporting module 344 may generate automated reports based on predefined templates, thus saving users time and reducing errors. This may be useful for businesses, for example, that need to generate regular reports, such as sales reports, inventory reports, or others.

Weather data integration module 348 may integrate with a weather data service to include within a location digest weather forecasts and real-time weather data. This may enable enterprises to optimize their decision-making. For instance, businesses in the agricultural sector may use weather data to plan irrigation schedules, plan crop harvests and planting, and perform other weather sensitive tasks.

Satellite imagery integration module 352 may integrate satellite imagery with a location intelligence digest to provide high resolution and up-to-date satellite images for specific locations. These images may be useful in many contexts such as construction, real estate, site selection, project planning, and monitoring.

NLP module 356 may enhance the functionality of orchestrator 300 by enabling users to search for and analyze location-based data using natural language queries. In an illustrative example, location intelligence orchestrator 300 enter operates with a large language model (LLM) or chatbot, which has been trained on location intelligence data, or that is instructed to select information from a location intelligence digest. NLP features may make the system more accessible to users with limited GIS experience, and enable businesses to gain insights quickly. NLP module 356 may also scrape websites for content that may be included in the location intelligence digest, and classify documents within a database. NLP data may also be used to extract location related information from unstructured data sources such as social media posts, online reviews, and others. NLP may be used as one method of digesting geospatial data that may be provided in different and incompatible formats.

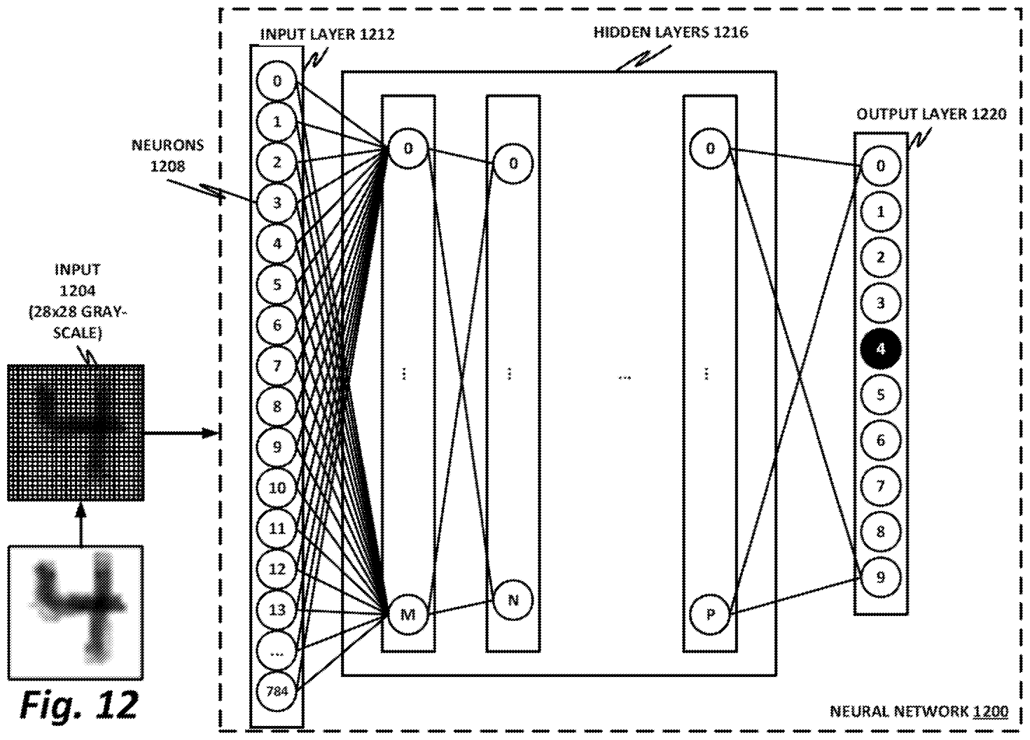

Image recognition module 360 may use a machine learning algorithms such as a neural network to enable businesses to extract insights from location-based images. For example, FIGS. 12-15 below illustrate some foundational principles of neural network processing that are applicable not only to this module, but to any of the machine learning algorithms illustrated herein. One illustrative application of image recognition module 360 is in the insurance industry, in which an AI model can be trained to recognize images of damaged property and vehicles. This may help insurance adjusters to process claims quickly and accurately. In another use case, in the retail industry, the system may be used to analyze customer behavior through in-store cameras, providing insights into customer traffic patterns and product preferences. In general, using ML for image recognition may enable more efficient and effective decision-making based on visual data.

Geospatial AI module 364 may analyze location-based data and provide businesses with insights into patterns and trends. This may enable businesses to make informed decisions and optimize processes to increase efficiency and reduce costs.

Geospatial AI module 364 may provide various types of machine learning. For example, the module may provide a clustering algorithm. Clustering algorithms may be used to group similar locations together based on featurized criteria. Features may include location proximity, demographic characteristics, business activity, and others. Clustering can help businesses to identify areas with high potential for growth or target specific customer segments.

Neural networks may be used to model complex patterns and location data. A neural network may be used to predict, for example, traffic or demand for specific products or services, which predictions may be based on location and time of day.

Decision trees may be used to model the relationships between different variables, such as demographic characteristics and customer behavior. Decision trees may also predict the most likely outcomes based on location data.

Secure private cloud environment 368 may provide encryption of private data within a private cloud environment to ensure user privacy. This may help protect sensitive data so that it is accessible only to the authorized user.

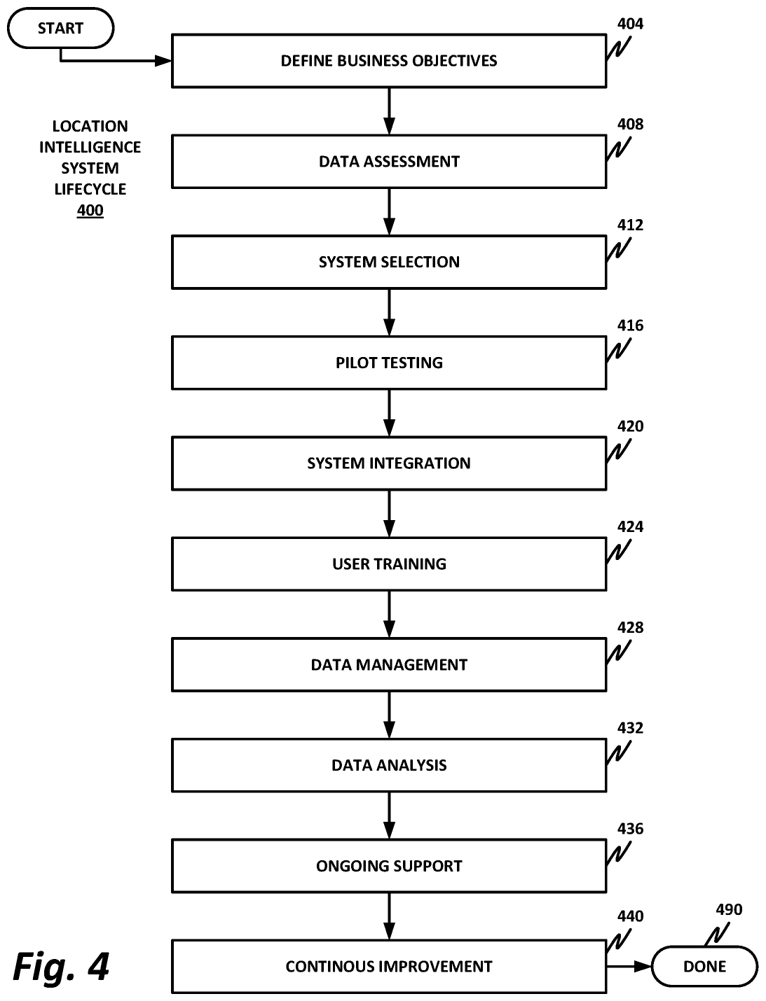

FIG. 4 is a flowchart of selected elements of providing a location intelligence system lifecycle 400. FIG. 4 is illustrated in terms of an “operator,” which may include a business entity, software vendor, or other service provider that provides a location intelligence orchestrator.

In block 404, the operator defines the business objectives. Defining business objectives may include identifying goals and objectives of the business that the location intelligence orchestrator will support. This may include determining specific areas of the business that need improvement, and determining how location intelligence can improve those business operations.

In block 408, the operator performs data assessment. Assessing data may include data already available within the organization, and may also include determining how to integrate those data. This operation may further include determining gaps in the data that need to be filled, and identifying sources of geospatial data that can be used to fill those gaps and integrated into the system.

In block 412, the operator provides system selection. The operator may identify potential location intelligence orchestrator functions that meet the organization's needs. The operator may also evaluate the system against a set of—criteria such as functionality, scalability, user-friendliness, security and cost.

In block 416, the operator provides pilot testing. The operator may conduct a pilot test of the location intelligence orchestrator to ensure that it meets the business needs and user requirements of the target enterprise. The operator may further identify potential issues or challenges that should be addressed.

In block 420, the operator provides system integration. This may include integrating location intelligence orchestrator with other systems within the organization, such as ERP, CRM, accounting systems, real-time data sources, and other systems. Proper integration eases operation of the location intelligence orchestrator within the business workflow and data management.

In block 424, the operator may provide user training. Training may include instruction to stakeholders in the organization who will use the services of the orchestrator. Users may be trained in system functionality, data management, and analytics.

In operation 428, the operator performs data management. The operator may establish data management protocols for the location intelligence orchestrator. This may include establishing data security and privacy policies, data backup procedures, and regular data maintenance tasks.

In block 432, the operator provides data analysis. The operator or the enterprise may use location intelligence orchestrator to analyze geospatial data and gain insights into how the organization can optimize its operations. Data analysis may include using the orchestrator's data visualization tools and predictive analytics capabilities to identify data of interest, and to understand their implications.

In block 436, the operator provides ongoing support and maintenance. This may include regular updates, bug fixes, and user support.

In block 440, the operator provides continuous improvement. The operator may continuously evaluate the location intelligence orchestrator's performance against business objectives, and identify opportunities for improvement. The operator may analyze user feedback and identify areas where the orchestrator may be improved to meet evolving needs of the organization.

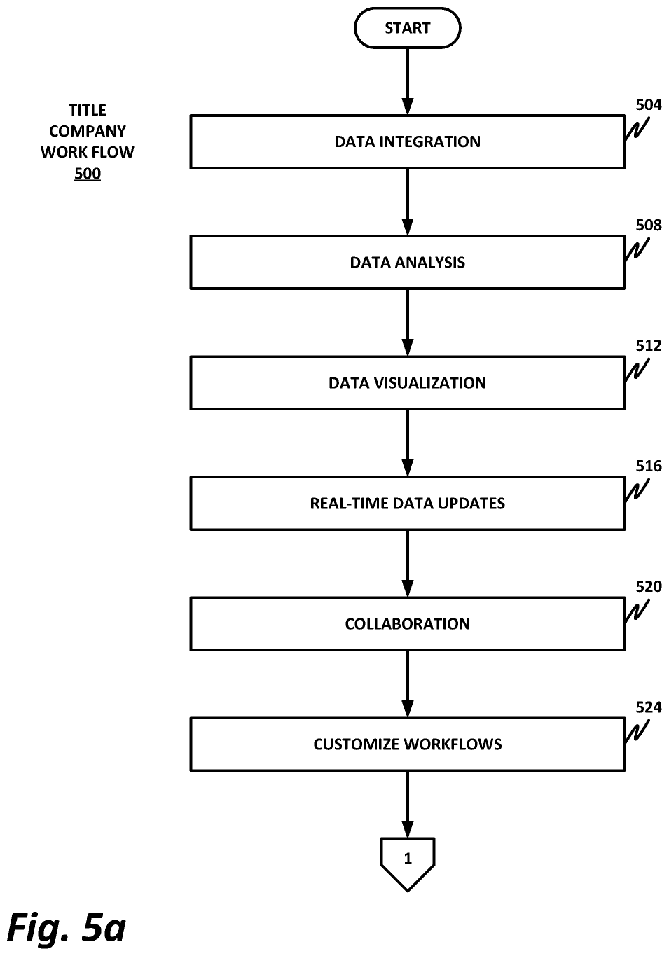

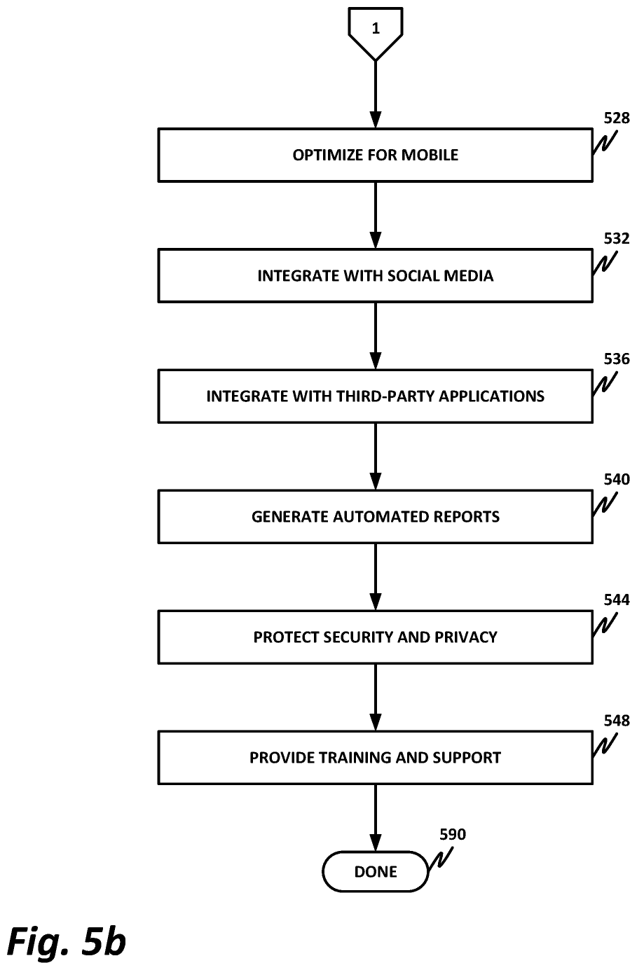

FIGS. 5a and 5b provide a flowchart of a title company workflow 500. Title company workflow 500 represents an embodiment in which a title company uses a location intelligence orchestrator to support its business work flows.

In block 504, the operator provides data integration. This may include integrating relevant legacy data sources, such as property boundaries, tax information, and scanned legal documents from online providers. These data may be imported and managed within the system. In an illustrative example, a machine learning classifier may be used to classify imported documents.

In block 508, the orchestrator provides data analysis. The orchestrator made analyze the data using for example advanced geospatial AI and ML algorithms. The scanning may enable the title company to gain unique insights into market trends and property values, which may inform their decision-making.

In block 512, the orchestrator provides data visualization. The orchestrator's data visualization tools may be used to display analyze data in various formats, such as charts, graphs, heat maps, and others. These displays may allow the title company to easily understand and digest data and to communicate the data to their clients.

In block 516, the orchestrator provides real-time data updates. The orchestrator may be integrated with sensors and IoT devices to provide these real-time data. This integration provides the title company with up-to-date information on properties, enabling the title company to respond quickly to changes.

In block 520, the orchestrator provides collaboration. The collaboration tools may enable title companies to work together on projects, share data, and communicate in real-time with other employees, real estate agents and brokers, buyers and sellers, and government agencies. Collaboration tools may also work well with remote employees. Collaboration can improve workflow efficiency and reduce errors.

In block 524, the orchestrator provides customizable workflows. These workflows may allow the title company to tailor the system to its specific needs. Customizable workflows can improve efficiency and reduce errors.

Following off page connector 1 to FIG. 5b, in block 528 the orchestrator may optimize displays for mobile devices. Mobile optimization allows title company employees to access the system wherever they may be so long as they have data service. Integration with mobile devices may improve workflow efficiency and reduce errors.

In block 532, the orchestrator integrates with social media platforms. Social media integration allows the title company, for example, to analyze location-based data that include social trends. These data may provide insights into market trends and property values.

In block 536, the orchestrator provides integration with third-party applications. Third-party applications may include, for example, ERP, CRM, and accounting systems. Integration with legacy applications can improve efficiency and reduce errors.

In block 540, the orchestrator may generate automated reports. These reports may be based on predefined templates, which can save time and provide consistency.

In block 544, the orchestrator protects user and enterprise security and privacy. This may include providing a secure private cloud environment for running the orchestrator or certain aspects of the orchestrator. Clients can set up user permissions and access levels and restrict access to specific data and services.

In block 548, the operator provides training and support. The operator may train employees and agents in online resources to improve their work with the orchestrator. Training may include on-site training with dedicated support staff. Clients may receive ongoing support and updates to ensure that they receive benefits from the orchestrator, and to respond to issues or concerns that arise.

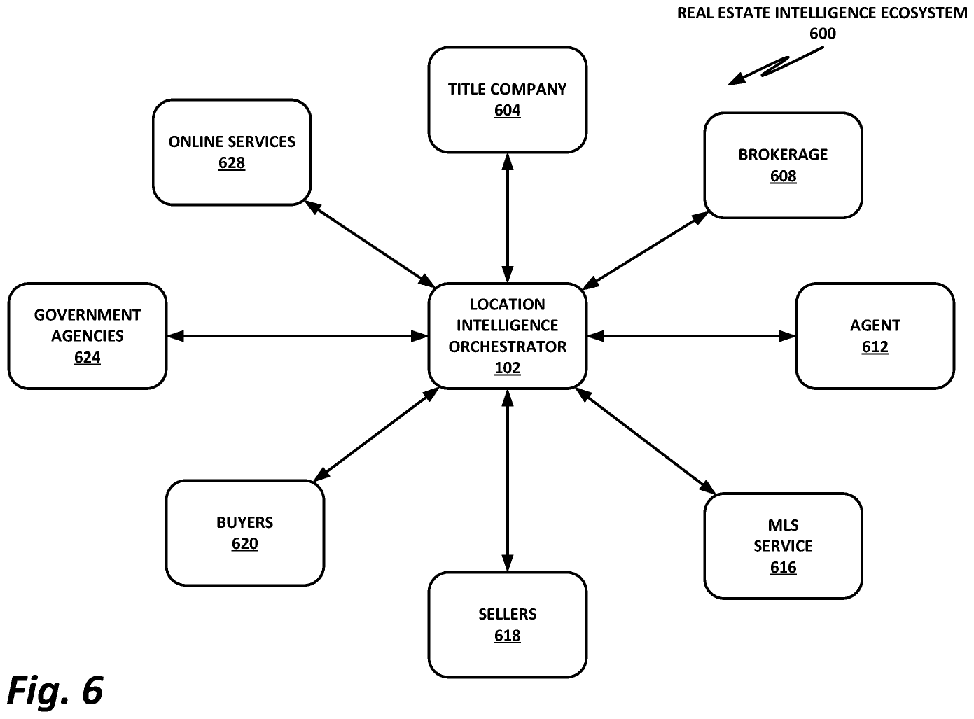

FIG. 6 is a block diagram illustration of selected elements of a real estate intelligence ecosystem 600. In this case, location intelligence orchestrator 102 may be integrated with a real estate workflow. This may include interoperation with a title company 604, a brokerage 608, one or more real estate agents 612, an MLS service 616, sellers 618, buyers 620, government agencies 624, and one or more online services 628 by way of illustrative and nonlimiting example.

The proliferation of online tools and data sources has caused a substantial shift in the real estate industry in recent years. However, data sources are disparate and often incompatible. Location intelligence orchestrator 102 can collate and standardize such data to provide location intelligence digests to various entities.

The real estate industry generates large volumes of data, and the industry can benefit from tools to analyze, interpret, and standardize the data. These processes may lead to better insights into market trends and more informed decision-making. Real estate data are often fragmented and difficult to access, making it difficult for buyers, sellers, and investors to make informed decisions. The location intelligence orchestrator of the present specification centralizes access to these data and provides comprehensive data on property prices, demographics, and other factors that influence real estate transactions.

Orchestrator 102 may also provide enhanced transparency in the real estate industry. Real estate transactions are complex, and the involvement of multiple stakeholders, including brokers, agents, buyers, sellers, lawyers, title companies, and others can make the process opaque to ordinary individuals. Location intelligence orchestrator 102 may provide a simple dashboard where users can see relevant information in one place without having to hunt in multiple sources. This may improve efficiency, particularly for an industry that is often associated with slow and inefficient processes. Streamlining the buying and selling processes may provide faster and more reliable appraisals, inspections, financing, and closing of transactions.

Orchestrator 102 can also ease the process of digitization. The real estate industry has made progress in digitizing some aspects of the buying and selling process, such as via the use of online document execution. However, these online contracts represent yet another data source in yet another format. Location intelligence orchestrator 102 may receive these documents as a data source, and use for example a machine learning classifier to classify the documents appropriately as, for example, earnest money contracts, purchase agreements, closing documents, or others. The use of machine learning to digest and standardize data may address a previous lack of data standardization in the real estate industry. This lack of standardization can make it difficult for buyers, sellers, and real estate professionals to access accurate and comprehensive information, or even to know if information is missing. By providing a single location to collect, share, and display data, location intelligence orchestrator 102 may improve transparency and facilitate more efficient transactions.

Advantageously, developers can incorporate green building practices and technology, while property managers can implement energy-efficient measures and reduce waste. The real estate industry can also benefit from more accessible housing. Accessibility may be viewed in terms of both affordability and physical accessibility features for people with disabilities. Better data and higher efficiency can help address the affordability crisis in the current housing market, and better data sources can help individuals with disabilities more easily find properties that address their needs.

Orchestrator 102 also provides sustainability information. The real estate industry has a significant impact on the environment, and current trends are for more sustainable and energy-efficient buildings. The industry may benefit from more focus on sustainability, including developing new materials, technologies, building practices, and carbon footprint policies. The orchestrator may aid developers in incorporating green building practices and technologies, and property managers in implementing energy-efficient measures and reducing waste.

Location intelligence orchestrator 102 may also provide an enhanced and more enjoyable customer experience. The real estate industry and the maze of laws, regulations, forms, and legalities can be overwhelming for buyers and sellers, and in particular for new buyers and sellers. Location intelligence orchestrator 102 can improve the customer experience by providing a user-friendly interface and better communication tools to build trust and loyalty.

Location intelligence orchestrator 102 can also help to provide better diversity and inclusion. For example, integration of various data sources can provide better demographic information, and can lead to better representation of women and people of color in leadership positions and in hiring practices.

Location intelligence may be defined as the process of deriving insights from geospatial data, where geospatial data may include data that have a location component. In the real estate industry, location intelligence may be used to analyze market trends, demographic information, and other geospatial data to identify opportunities and to make more informed decision. For example, location intelligence may be used to analyze the proximity of a property to schools, public transportation, and other amenities, which may impact its value. These data may also be used to identify areas that are experiencing growth or that have potential for future development.

Location intelligence may be useful in various aspects of the real estate industry. For example, site selection may benefit from better location intelligence. These data may be used to identify the best location for new development, or to determine the potential profitability of a particular area. Location intelligence may also support market analysis. The data may be used to analyze market trends and identify opportunities in specific locations. For example, the data may be used to determine which neighborhoods are experiencing growth, or which areas have a high demand for rental properties.

Location intelligence may also support risk assessment. The data may be used to assess risk factors, such as environmental hazards, crime rates, and other related data, which may impact the value and market billable marketability of a property.

Location intelligence may also be used for asset management. The data may be used to monitor and manage assets, such as rental properties or commercial buildings. This may help owners and managers to optimize their properties for product maximum profitability.

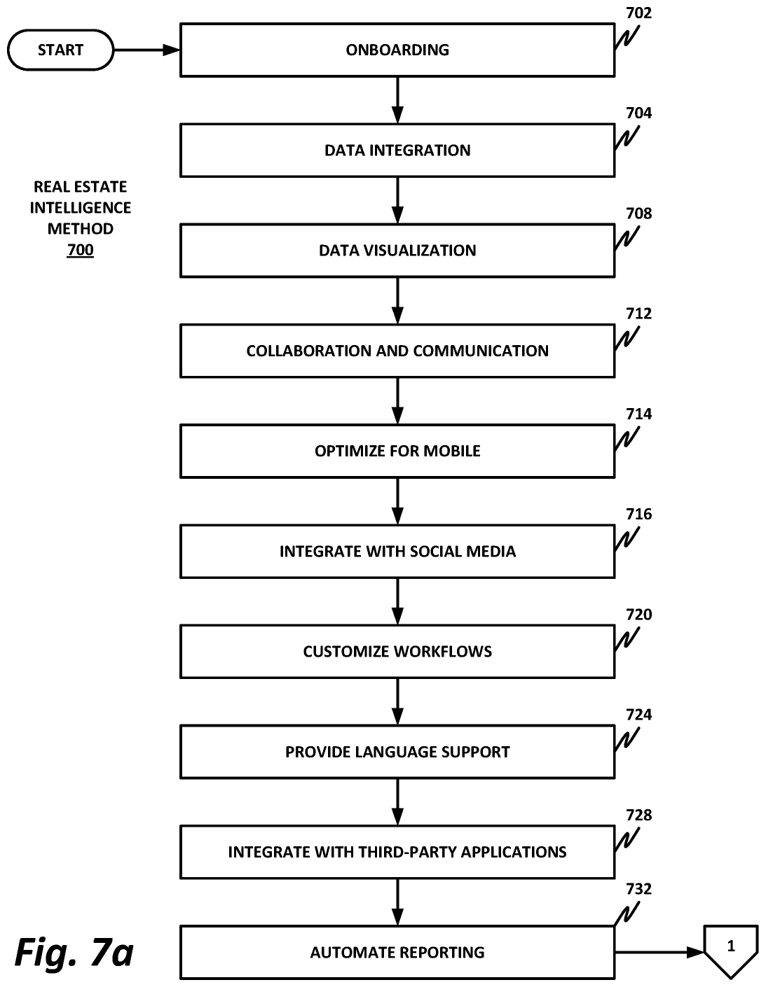

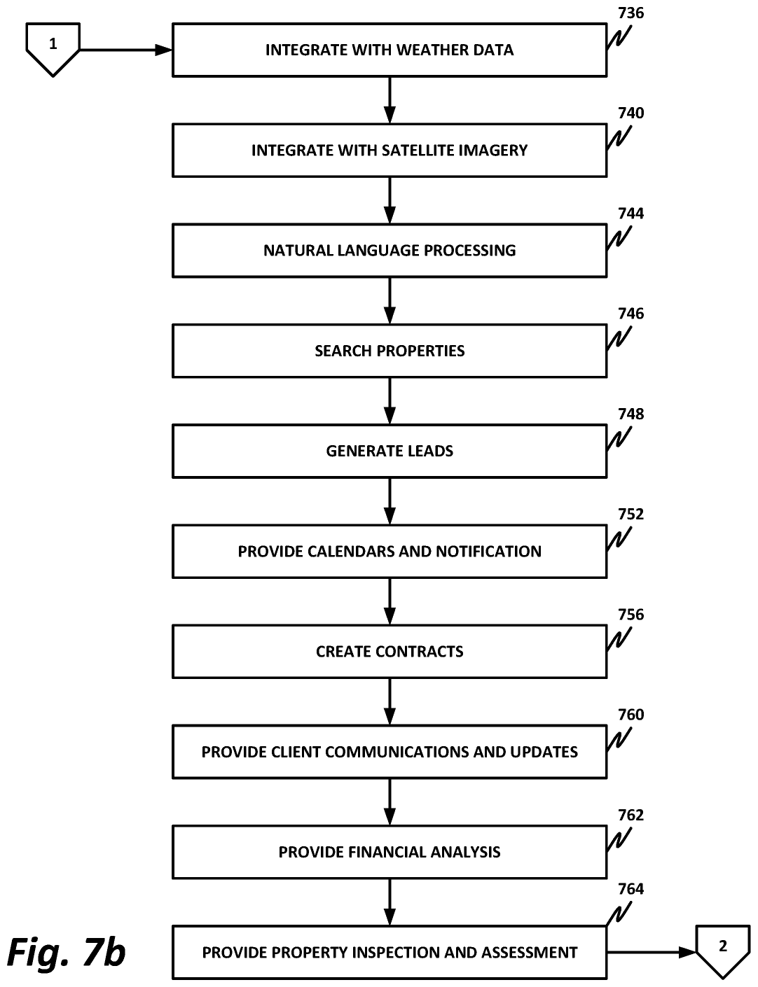

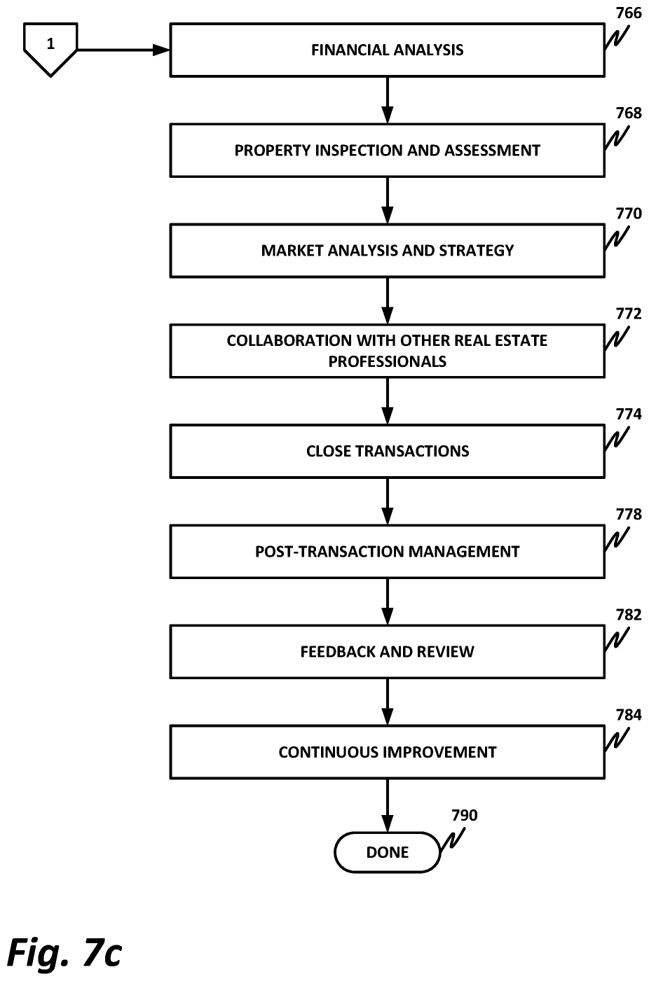

FIGS. 7a-7c provide an illustrative real estate intelligence method 700.

In block 702, the operator provides onboarding. Real estate brokers and agents may sign up for access to a location intelligence orchestrator, and set up accounts.

In block 704, the operator provides data integration. Brokers and agents may integrate their existing data into the platform, including property listings, transaction data, demographic data, economic data, market trends, zoning and regulatory data, environmental data, and property ownership data.

In block 708, the orchestrator provides data visualization and analytics. Brokers and agents may use the orchestrator's geospatial AI and ML algorithms to visualize and analyze their data, thus gaining valuable insights into market conditions. This may enable brokers and agents to make better data-driven decisions.

In block 712, the orchestrator provides collaboration and communication. Brokers and agents may use the orchestrator's collaboration tools and communication features to work together and communicate with each other and with clients, such as by showing property information and coordinating property tours. Collaboration tools may also help to integrate operations between brokers representing buyers and sellers, title companies, law offices, and county offices.

In block 714, the orchestrator may provide mobile optimization. Brokers and agents may use the orchestrator's mobile optimization features to accessor data and to work remotely, such as while showing properties to clients. This may provide valuable access to real-time data and information responsive to user questions or concerns. This can increase confidence on the part of buyers and sellers, help agents build relationships with their client base, and increase trust in the real estate profession overall.

In block 716, the orchestrator integrates with social media services and platforms. For example, brokers and agents may use the orchestrator's social media integration features to promote their properties and services on social media platforms, such as by providing virtual tours and listings, organizing events, and sending out messages.

In block 720, the orchestrator provides customizable workflows. Brokers and agents may use customizable workflows to streamline their operations and automate repetitive tasks, such as scoring leads and qualifying buyers.

In block 724, the orchestrator may provide language support functions. Brokers and agents may use the orchestrator's language support features to communicate with clients in a preferred language. Automated or machine translation tools may enable brokers and agents to work with clients even if they do not speak a common language.

In block 728, the orchestrator provides integration with third-party data and software. Brokers and agents may use the orchestrator's third-party application integration features to connect with other real estate tools and services, including legacy tools and services. These may include, by way of illustrative and nonlimiting example, mortgage calculators and property management software.

In block 732, the orchestrator provides automated reporting. The automated reporting features may generate reports on performance metrics, such as sales volume and customer satisfaction. Automated reporting may also report information such as trends in sales, trends in prices, and changes in demographic data.

Following off-page connector 1 to FIG. 7b, in block 736, the orchestrator may integrate with weather data. Brokers and agents may use the orchestrator's integration with weather data to monitor and analyze the impact of weather conditions on the real estate market. This may also help them to schedule events, including showings, open houses, and other events that may be affected by weather.

In block 740, the orchestrator integrates with satellite imagery. Satellite imagery integration may be used to visualize and analyze physical features of properties and surrounding areas. This can provide buyers with a first-pass view of a property and its neighborhood without even having to go to the physical location.

In block 744, the orchestrator provides NLP services. The NLP features may analyze and interpret unstructured data, including data available from various sources such as websites, county records, social media posts, contracts, user feedback, and other. These data can be integrated into a location intelligence digest even though the original data sources are not natively compatible with one another.

In block 746, the orchestrator may provide property search. Clients may use the property search feature to search for properties that match various criteria, such as location and price range.

In block 748, the orchestrator may provide lead generation services. Brokers and agents may use the lead generation features to generate new leads and opportunities, such as through marketing campaigns and referral programs.

In block 752, the system may provide calendar and event notifications. This may integrate various data sources with a broker's or agent's calendar system. This may enable brokers and agents to better manage their schedules and be aware of important deadlines and events. Furthermore, this can eliminate the need to manually add events to a calendar.

In block 756, the orchestrator may provide contract creation. The contract creation features may be available to generate contracts between buyers and sellers, and may use templates and customization options.

In block 760, the orchestrator may provide client communications and updates. Brokers and agents may use the orchestrator's client communication and update features to keep client informed about the progress of their transactions, updates on new properties, or opportunities to buy and sell, and to address concerns or questions that clients may have.

Following off page connector 2 to FIG. 7c, in block 766, the orchestrator provides financial analysis. Brokers and agents may use the orchestrator's financial analysis tools to analyze financial data, such as mortgage rates, loan terms, and tax implement implications. Brokers and agents may use these data to help their clients make informed decisions about real estate investments.

In block 768, the orchestrator may provide property inspection and assessment tools. Brokers and agents may use these tools to conduct property inspections and assessments to ensure that properties meet quality and safety standards.

In block 770, the orchestrator may provide market analysis and strategy tools. Brokers and agents may use these tools to analyze market trends and conditions, and to develop effective marketing and pricing strategies. This may help them to maximize the value of properties.

In block 772, the orchestrator provides collaboration tools that enable collaboration between different real estate professionals.

In block 774, the orchestrator provides tools to support the close of transactions. This may ease the process of transferring ownership, paying fees and commissions, and completing the necessary paperwork.

In block 778, the orchestrator may provide post transaction management tools. These tools may help brokers and agents to manage ongoing tasks, such as property management and maintenance, and to keep in touch with clients for future opportunities.

In block 782, the orchestrator and the operator may incorporate feedback and review. For example, clients may use the orchestrator's feedback and review features to leave feedback about the orchestrator and provide reviews of their experience.

In block 784, the orchestrator supports a continuous improvement cycle. Brokers and agents may use the orchestrator's continuous improvement features to monitor their performance metrics and improve their services, such as identifying areas where they can improve customer satisfaction or streamline operations.

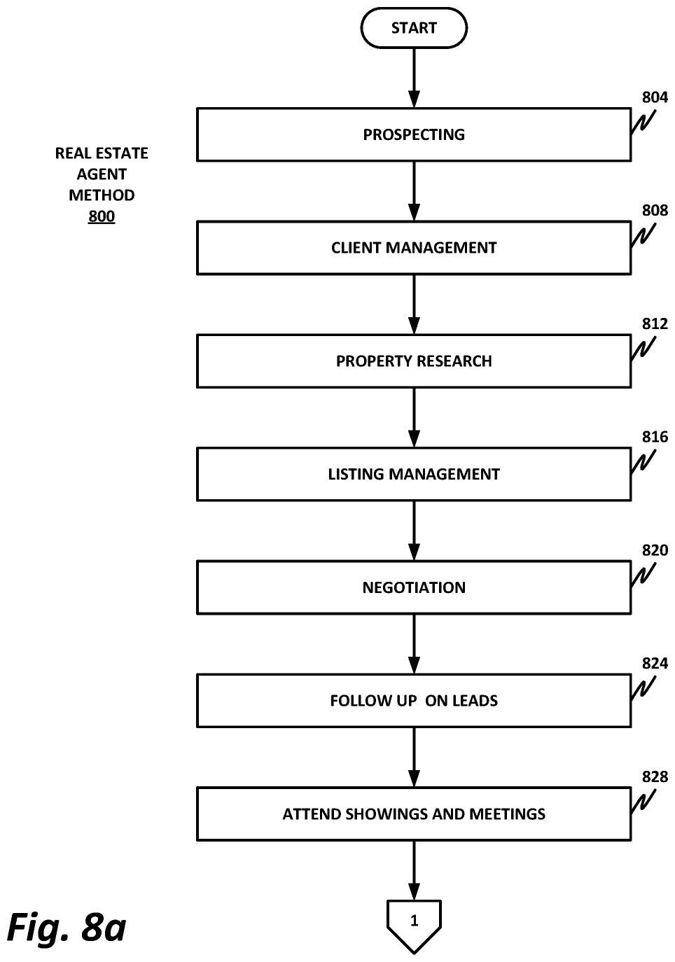

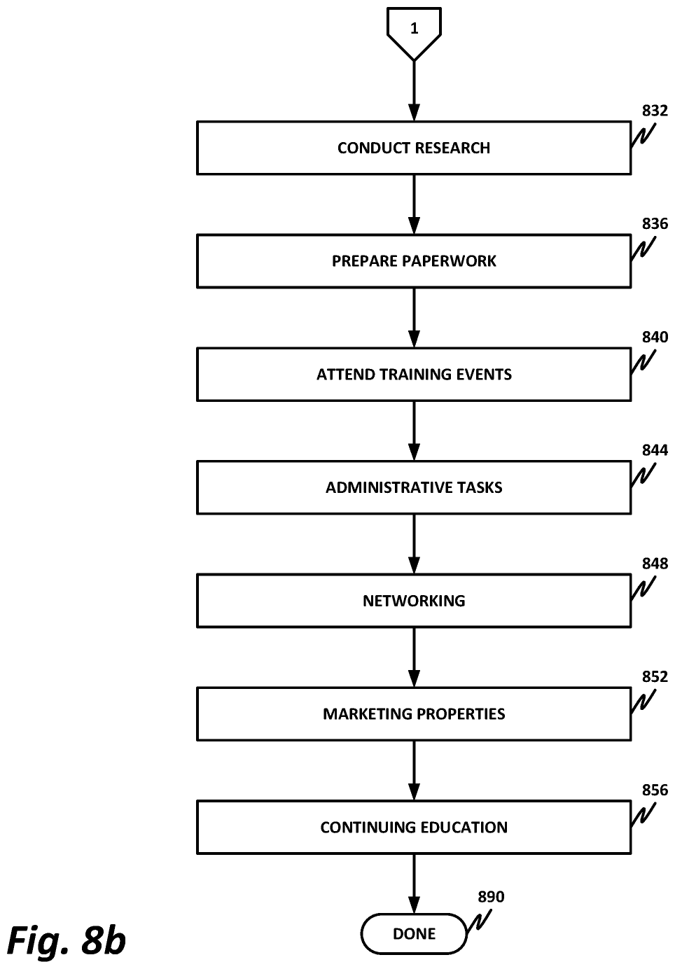

FIGS. 8a and 8b is a flowchart of selected elements of a real estate agent method 800. Method 800 represents a use case for a real estate agent operating with a location intelligence orchestrator as illustrated herein. The daily workflow of a real estate agent or broker may vary based on specific responsibilities and client needs. However, the operations illustrated here provide an example of some of the ways that the agent may use the orchestrator.

In block 804, the agent may start her day with prospecting. Prospecting may include identifying new potential clients through various channels such as online advertising, referrals, open houses, social media, and other marketing strategies. In one illustrative example, the orchestrator provides a prospecting report with the data available to assist the agent in her prospecting activity.

In block 808, the agent performs client management. The agent may need to keep in touch with her existing clients, respond to queries, and keep clients updated with relevant information related to their properties. She may also meet with potential clients to discuss their needs and preferences and show them properties that match their criteria. In an illustrative example, the location intelligence orchestrator provides a client management screen that displays to the agent relevant data for client management functions.

As part of client management 808, the agent may schedule showings and meetings. The agent might schedule showings for clients who want to view properties, or meetings with other agents, lenders, or service providers. These meetings may be in person, virtual, or by phone. The orchestrator may provide collaboration tools that may facilitate these meetings, including integration with online meeting software. Furthermore, the orchestrator may provide calendaring services that help the agent to manage her calendar and her obligations.

In block 812, the agent may perform a property search. She may continuously monitor the local real estate market and conduct research on properties to learn more about pricing trends, availability, and other factors that may impact her clients buying or selling decisions. In an illustrative example, the location intelligence orchestrator provides a property research interface that aggregates relevant data.

In block 816, the agent performs listing management. If the agent is representing a seller, she may need to handle the listing of the property. This may include taking photographs, preparing virtual tours, creating online listings, hosting open houses, and communicating with potential buyers. The location intelligence orchestrator may provide relevant data to aid with listing management.

In block 820, the agent may perform negotiation. Real estate agents are often involved in negotiations, which include working with buyers or sellers to arrive at a mutually agreeable purchase terms. The orchestrator may provide a negotiation interface that displays to the agent relevant information that may aid her in performing these negotiations.

In block 824, the agent may follow up on leads. This may include leads from potential clients or interested buyers who have contacted her previously. She might call, text, or email clients to continue the conversation and see if they can schedule a meeting or showing. The orchestrator may display relevant information such as recent contacts, contact information, date since last contact, and other information that may assist the agent in following up on her leads.

In block 832, the agent may conduct research. The agent might research properties, neighborhoods, and market trends to stay informed and to provide the best advice to her clients. The orchestrator may facilitate the agent's research by collating various sources of data, and presenting a geospatial intelligence digest for particular locations, which may simplify research operations.

In block 836, the agent may prepare paperwork. Agents spend time preparing and reviewing paperwork, such as contracts, disclosures, and other legal documents related to the buying and selling process. The location intelligence orchestrator may collate these documents into a single location, and assist the agent in preparing and reviewing documents.

In block 840, the agent may attend training events. Training sessions may help the agent to stay current on industry trends and regulations, and help her to build relationships with other industry professionals who also attend training events.

In block 844, the agent performs administrative tasks. The agent may spend time on tasks such as checking and responding to emails and voicemails, updating client files, and managing her website and social media presence. She may also need to keep track of her schedule. The orchestrator may provide relevant information feeds to aid her in this process, and may include an API or hooks into her third-party calendaring software.

In block 848, the agent engages in networking. Networking is an important part of the agent's job as she needs to develop a network of industry professionals, including other agents, mortgage brokers, home inspectors, and others who can help her with her transactions. The location intelligence orchestrator may help the agent to maintain her network of contacts, including relevant information about the people.

In block 852, the agent may engage in marketing properties. She may create and distribute marketing materials for properties, such as brochures, flyers, and online listings. The orchestrator may help her to manage these data and may include interfaces to tools that help her create the content.

In block 856, the agent engages in continuing education. This may help the agent to keep up with industry trends and regulations, such as by attending training sessions, seminars, and conferences.

In support of these functions, the location intelligence orchestrator may maintain various sources of data and attributes that are relevant to the real estate industry. These data may vary depending on the specific application or use cases. Some common data that may be collated, aggregated, and displayed by a location intelligence orchestrator include the following by way of illustrative and nonlimiting example.
Property characteristics: this includes information about the physical features of the property such as its location, size, number of bedrooms, number of bathrooms, age, and condition.
Location: this includes data about the neighborhood, school districts, proximity to public transportation, and other factors that may affect the desirability and value of a property.
Property type: this includes the type of property, such as single-family homes, multifamily units, commercial buildings, and vacant land.
Size in square footage: this includes the size of a property and its square footage, as well as the size of its lot.
Condition and age: this includes the age and condition of a property, which may affect its value and marketability.
Transaction data: this includes information about past sales and rental transactions of similar properties in the same or nearby areas, as well as the terms of transactions, such as sale price, rental price, and duration of lease.
Demographic data: this includes information about the characteristics of the population in the area, such as age, income level, educational attainment, and employment status.
Economic data: this includes information about the local and national economic conditions, such as interest rates, inflation, employment rates, and GDP.
Market trends: this includes information about current and historical trends in the real estate market, such as changes in supply and demand, inventory levels, and average days on market.
Zoning and regulatory data: this includes information about local zoning regulations, building codes, and other legal requirements that may affect the use or development of a property.
Environmental data: this includes information about the environmental conditions in the area, such as air and water quality, potential environmental hazards, historic floodplains, and impacts of natural disasters.
Property ownership data: this includes information about current and past owners of property, and any liens or encumbrances on the property.

FIG. 9 is a block diagram of a hardware platform 900. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 900, even though they may be scattered across a data center, or even located in different data centers.

Hardware platform 900 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 900 is arranged in a point-to-point (PtP) configuration. This PtP configuration is popular for personal computer (PC) and server-type devices, although it is not so limited, and any other bus type may be used.

Hardware platform 900 is an example of a platform that may be used to implement embodiments of the teachings of this specification. For example, instructions could be stored in storage 950. Instructions could also be transmitted to the hardware platform in an ethereal form, such as via a network interface, or retrieved from another source via any suitable interconnect. Once received (from any source), the instructions may be loaded into memory 904, and may then be executed by one or more processor 902 to provide elements such as an operating system 906, operational agents 908, or data 912.

Hardware platform 900 may include several processors 902. For simplicity and clarity, only processors PROC0 902-1 and PROC1 902-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 902 may be any type of processor and may communicatively couple to chipset 916 via, for example, PtP interfaces. Chipset 916 may also exchange data with other elements, such as a high performance graphics adapter 922. In alternative embodiments, any or all of the PtP links illustrated in FIG. 9 could be implemented as any type of bus, or other configuration rather than a PtP link. In various embodiments, chipset 916 may reside on the same die or package as a processor 902 or on one or more different dies or packages. Each chipset may support any suitable number of processors 902. A chipset 916 (which may be a chipset, uncore, Northbridge, Southbridge, or other suitable logic and circuitry) may also include one or more controllers to couple other components to one or more central processor units (CPU).

Two memories, 904-1 and 904-2 are shown, connected to PROC0 902-1 and PROC1 902-2, respectively. As an example, each processor is shown connected to its memory in a direct memory access (DMA) configuration, though other memory architectures are possible, including ones in which memory 904 communicates with a processor 902 via a bus. For example, some memories may be connected via a system bus, or in a data center, memory may be accessible in a remote DMA (RDMA) configuration.

Memory 904 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 904 may be used for short, medium, and/or long-term storage. Memory 904 may store any suitable data or information utilized by platform logic. In some embodiments, memory 904 may also comprise storage for instructions that may be executed by the cores of processors 902 or other processing elements (e.g., logic resident on chipsets 916) to provide functionality.

In certain embodiments, memory 904 may comprise a relatively low-latency volatile main memory, while storage 950 may comprise a relatively higher-latency nonvolatile memory. However, memory 904 and storage 950 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 904 and storage 950, for example, in a single physical memory device, and in other cases, memory 904 and/or storage 950 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 922 may be configured to provide a human-readable visual output, such as a command-line interface (CLI) or graphical desktop such as Microsoft Windows, Apple OSX desktop, or a Unix/Linux X Window System-based desktop. Graphics adapter 922 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 922 may include a hardware graphics card, which may have its own memory and its own graphics processing unit (GPU).

Chipset 916 may be in communication with a bus 928 via an interface circuit. Bus 928 may have one or more devices that communicate over it, such as a bus bridge 932, I/O devices 935, accelerators 946, communication devices 940, and a keyboard and/or mouse 938, by way of nonlimiting example. In general terms, the elements of hardware platform 900 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 940 can broadly include any communication not covered by a network interface and the various I/O devices described herein. This may include, for example, various universal serial bus (USB), FireWire, Lightning, or other serial or parallel devices that provide communications.

I/O Devices 935 may be configured to interface with any auxiliary device that connects to hardware platform 900 but that is not necessarily a part of the core architecture of hardware platform 900. A peripheral may be operable to provide extended functionality to hardware platform 900, and may or may not be wholly dependent on hardware platform 900. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 942 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 932 may be in communication with other devices such as a keyboard/mouse 938 (or other input devices such as a touch screen, trackball, etc.), communication devices 940 (such as modems, network interface devices, peripheral interfaces such as PCI or PCIe, or other types of communication devices that may communicate through a network), audio I/O 942, a data storage device 944, and/or accelerators 946. In alternative embodiments, any portions of the bus architectures could be implemented with one or more PtP links.

Operating system 906 may be, for example, Microsoft Windows, Linux, UNIX, Mac OS X, IOS, MS-DOS, or an embedded or real-time operating system (including embedded or real-time flavors of the foregoing). In some embodiments, a hardware platform 900 may function as a host platform for one or more guest systems that invoke application (e.g., operational agents 908).

Operational agents 908 may include one or more computing engines that may include one or more nontransitory computer-readable mediums having stored thereon executable instructions operable to instruct a processor to provide operational functions. At an appropriate time, such as upon booting hardware platform 900 or upon a command from operating system 906 or a user or security administrator, a processor 902 may retrieve a copy of the operational agent (or software portions thereof) from storage 950 and load it into memory 904. Processor 902 may then iteratively execute the instructions of operational agents 908 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 900 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCOE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 900 may be virtualized, in particular the processor(s) and memory. For example, a virtualized environment may run on OS 906, or OS 906 could be replaced with a hypervisor or virtual machine manager. In this configuration, a virtual machine running on hardware platform 900 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 9 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

FIG. 10 is a block diagram of a NFV infrastructure 1000. NFV is an example of virtualization, and the virtualization infrastructure here can also be used to realize traditional VMs. Various functions described above may be realized as VMs, such as various aspects of a location intelligence orchestrator.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1000. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 10, an NFV orchestrator 1001 may manage several VNFs 1012 running on an NFVI 1000. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1001 a valuable system resource. Note that NFV orchestrator 1001 may provide a browser-based or graphical configuration interface, and in some embodiments may be integrated with SDN orchestration functions.

Note that NFV orchestrator 1001 itself may be virtualized (rather than a special-purpose hardware appliance). NFV orchestrator 1001 may be integrated within an existing SDN system, wherein an operations support system (OSS) manages the SDN. This may interact with cloud resource management systems (e.g., OpenStack) to provide NFV orchestration. An NFVI 1000 may include the hardware, software, and other infrastructure to enable VNFs to run. This may include a hardware platform 1002 on which one or more VMs 1004 may run. For example, hardware platform 1002-1 in this example runs VMs 1004-1 and 1004-2. Hardware platform 1002-2 runs VMs 1004-3 and 1004-4. Each hardware platform 1002 may include a respective hypervisor 1020, virtual machine manager (VMM), or similar function, which may include and run on a native (bare metal) operating system, which may be minimal so as to consume very few resources. For example, hardware platform 1002-1 has hypervisor 1020-1, and hardware platform 1002-2 has hypervisor 1020-2.

Hardware platforms 1002 may be or comprise a rack or several racks of blade or slot servers (including, e.g., processors, memory, and storage), one or more data centers, other hardware resources distributed across one or more geographic locations, hardware switches, or network interfaces. An NFVI 1000 may also include the software architecture that enables hypervisors to run and be managed by NFV orchestrator 1001.

Running on NFVI 1000 are VMs 1004, each of which in this example is a VNF providing a virtual service appliance. Each VM 1004 in this example includes an instance of the Data Plane Development Kit (DPDK) 1016, a virtual operating system 1008, and an application providing the VNF 1012. For example, VM 1004-1 has virtual OS 1008-1, DPDK 1016-1, and VNF 1012-1. VM 1004-2 has virtual OS 1008-2, DPDK 1016-2, and VNF 1012-2. VM 1004-3 has virtual OS 1008-3, DPDK 1016-3, and VNF 1012-3. VM 1004-4 has virtual OS 1008-4, DPDK 1016-4, and VNF 1012-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 10 shows that a number of VNFs 1004 have been provisioned and exist within NFVI 1000. This FIGURE does not necessarily illustrate any relationship between the VNFs and the larger network, or the packet flows that NFVI 1000 may employ.

The illustrated DPDK instances 1016 provide a set of highly-optimized libraries for communicating across a virtual switch (vSwitch) 1022. Like VMs 1004, vSwitch 1022 is provisioned and allocated by a hypervisor 1020. The hypervisor uses a network interface to connect the hardware platform to the data center fabric (e.g., a host fabric interface (HFI)). This HFI may be shared by all VMs 1004 running on a hardware platform 1002. Thus, a vSwitch may be allocated to switch traffic between VMs 1004. The vSwitch may be a pure software vSwitch (e.g., a shared memory vSwitch), which may be optimized so that data are not moved between memory locations, but rather, the data may stay in one place, and pointers may be passed between VMs 1004 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1022 is illustrated, wherein vSwitch 1022 is shared between two or more physical hardware platforms 1002.

FIG. 11 is a block diagram of selected elements of a containerization infrastructure 1100. Like virtualization, containerization is a popular form of providing a guest infrastructure. Various functions described herein may be containerized, such as various aspects of a location intelligence orchestrator.

Containerization infrastructure 1100 runs on a hardware platform such as containerized server 1104. Containerized server 1104 may provide processors, memory, one or more network interfaces, accelerators, and/or other hardware resources.

Running on containerized server 1104 is a shared kernel 1108. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1108 is main operating system 1112. Commonly, main operating system 1112 is a Unix or Linux-based operating system, although containerization infrastructure is also available for other types of systems, including Microsoft Windows systems and Macintosh systems. Running on top of main operating system 1112 is a containerization layer 1116. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1112 may also provide services 1118, which provide services and interprocess communication to userspace applications 1120.

Services 1118 and userspace applications 1120 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1112, they inherit the same file and resource access permissions as those provided by shared kernel 1108. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1104, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1104).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors-especially type 1, or “bare metal,” hypervisors-provide such near-native performance that this advantage may not always be realized.

In this example, containerized server 1104 hosts two containers, namely container 1130 and container 1140.

Container 1130 may include a minimal operating system 1132 that runs on top of shared kernel 1108. Note that a minimal operating system is provided as an illustrative example, and is not mandatory. In fact, container 1130 may perform as full an operating system as is necessary or desirable. Minimal operating system 1132 is used here as an example simply to illustrate that in common practice, the minimal operating system necessary to support the function of the container (which in common practice, is a single or monolithic function) is provided.

On top of minimal operating system 1132, container 1130 may provide one or more services 1134. Finally, on top of services 1134, container 1130 may also provide userspace applications 1136, as necessary.

Container 1140 may include a minimal operating system 1142 that runs on top of shared kernel 1108. Note that a minimal operating system is provided as an illustrative example, and is not mandatory. In fact, container 1140 may perform as full an operating system as is necessary or desirable. Minimal operating system 1142 is used here as an example simply to illustrate that in common practice, the minimal operating system necessary to support the function of the container (which in common practice, is a single or monolithic function) is provided.

On top of minimal operating system 1142, container 1140 may provide one or more services 1144. Finally, on top of services 1144, container 1140 may also provide userspace applications 1146, as necessary.

Using containerization layer 1116, containerized server 1104 may run discrete containers, each one providing the minimal operating system and/or services necessary to provide a particular function. For example, containerized server 1104 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

FIGS. 12-14 illustrate selected elements of an artificial intelligence system or architecture. In these FIGURES, an elementary neural network is used as a representative embodiment of an artificial intelligence or machine learning architecture or engine. This should be understood to be a nonlimiting example, and other machine learning or artificial intelligence architectures are available, including for example symbolic learning, robotics, computer vision, pattern recognition, statistical learning, speech recognition, natural language processing, deep learning, convolutional neural networks, recurrent neural networks, object recognition and/or others.

FIG. 12 illustrates machine learning according to a “textbook” problem with real-world applications. In this case, a neural network 1200 is tasked with recognizing characters. To simplify the description, neural network 1200 is tasked only with recognizing single digits in the range of 0 through 9. These are provided as an input image 1204. In this example, input image 1204 is a 28×28-pixel 8-bit grayscale image. In other words, input image 1204 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 1200 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other artificial intelligence architecture, to meet the demands of a particular problem. Indeed, the architecture here is sometimes referred to as the “Hello World” problem of machine learning, and is provided as but one example of how the machine learning or artificial intelligence functions of the present specification could be implemented.

In this case, neural network 1200 includes an input layer 1212 and an output layer 1220. In principle, input layer 1212 receives an input such as input image 1204, and at output layer 1220, neural network 1200 “lights up” a perceptron that indicates which character neural network 1200 thinks is represented by input image 1204.

Between input layer 1212 and output layer 1220 are some number of hidden layers 1216. The number of hidden layers 1216 will depend on the problem to be solved, the available compute resources, and other design factors. In general, the more hidden layers 1216, and the more neurons per hidden layer, the more accurate the neural network 1200 may become. However, adding hidden layers and neurons also increases the complexity of the neural network, and its demand on compute resources. Thus, some design skill is required to determine the appropriate number of hidden layers 1216, and how many neurons are to be represented in each hidden layer 1216.

Input layer 1212 includes, in this example, 784 “neurons” 1208. Each neuron of input layer 1212 receives information from a single pixel of input image 1204. Because input image 1204 is a 28×28 grayscale image, it has 784 pixels. Thus, each neuron in input layer 1212 holds 8 bits of information, taken from a pixel of input layer 1204. This 8-bit value is the “activation” value for that neuron.

Each neuron in input layer 1212 has a connection to each neuron in the first hidden layer in the network. In this example, the first hidden layer has neurons labeled 0 through M. Each of the M+1 neurons is connected to all 784 neurons in input layer 1212. Each neuron in hidden layer 1216 includes a kernel or transfer function, which is described in greater detail below. The kernel or transfer function determines how much “weight” to assign each connection from input layer 1212. In other words, a neuron in hidden layer 1216 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 1216, until they reach the last layer, which has P+1 neurons labeled 0 through P. Each of these P+1 neurons has a connection to each neuron in output layer 1220. Output layer 1220 includes a number of neurons known as perceptrons that compute an activation value based on their weighted connections to each neuron in the last hidden layer 1216. The final activation value computed at output layer 1220 may be thought of as a “probability” that input image 1204 is the value represented by the perceptron. For example, if neural network 1200 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 1216 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (σ) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

$${a}_{0}^{( 1 )} = σ ( {w}_{0} {a}_{0}^{( 0 )} + {w}_{1} {a}_{1}^{( 0 )} + ⋯ {w}_{783} {a}_{783}^{( 0 )} + b )$$

In this case, it is assumed that layer 0 (input layer 1212) has 784 neurons. Where the previous layer has “n” neurons, the function can be generalized as:

$${a}_{0}^{( 1 )} = σ ( {w}_{0} {a}_{0}^{( 0 )} + {w}_{1} {a}_{1}^{( 0 )} + {⋯w}_{n} {a}_{n}^{( 0 )} + b )$$

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & ⋯ & {w}_{0 , n} \\ ⋮ & ⋱ & ⋮ \\ {w}_{( k , 0 )} & ⋯ & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

$${a}^{( 1 )} = σ ( {Wa}^{( 0 )} + b )$$

Neural connections and activation values are propagated throughout the hidden layers 1216 of the network in this way, until the network reaches output layer 1220. At output layer 1220, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 1220 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

Wherein w is a vector containing all of the parameters (weights and biases) in the network. The minimum (absolute and/or local) can then be represented as a trivial calculus problem, namely:

$$\frac{dC}{dw} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolutel minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

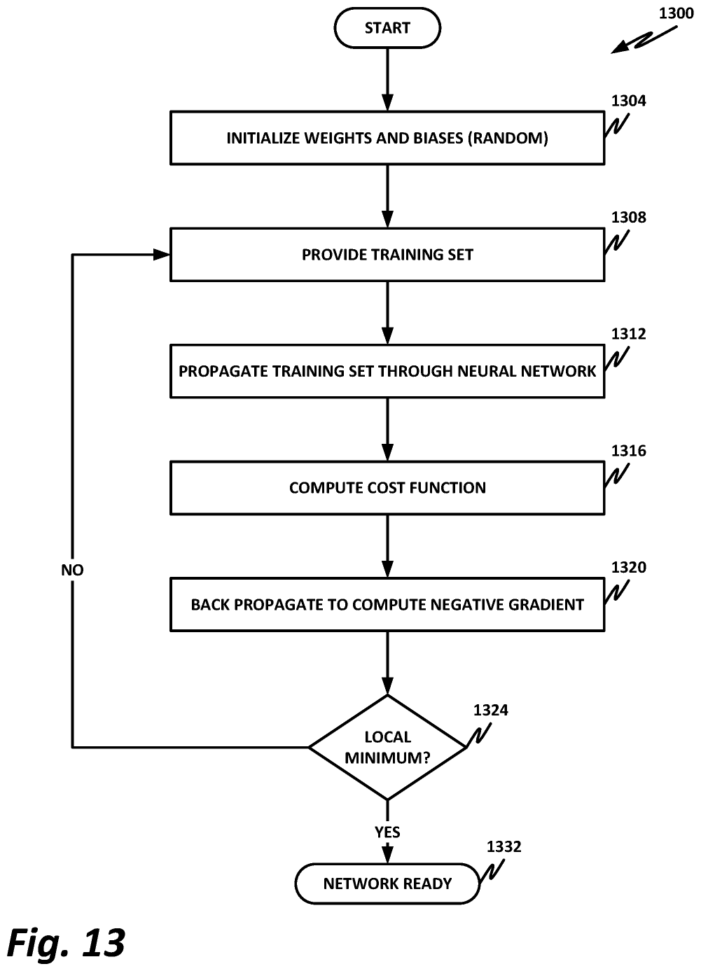

FIG. 13 is a flowchart of a method 1300. Method 1300 may be used to train a neural network, such as neural network 1200 of FIG. 12.

In block 1304, the network is initialized. Initially, neural network 1200 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1308, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1308, the initial training set is provided to the neural network. Alternatively, the full training set could be used in each iteration.

In block 1312, the training data are propagated through the neural network. Because the initial values are random, and are therefore essentially garbage, it is expected that the output will also be a garbage value. In other words, if neural network 1200 of FIG. 12 has not been trained, when input image 1204 is fed into the neural network, it is not expected with the first training set that output layer 1220 will light up perceptron 4. Rather, the perceptrons may have values that are all over the map, with no clear winner, and with very little relation to the number 4.

In block 1316, a cost function is computed as described above. For example, in neural network 1200, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1320, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1324, the system determines whether it has reached a local minimum (e.g., whether the gradient has reached 0 within the threshold). If the local minimum has not been reached, then the neural network has not been adequately trained, and control returns to block 1308 with a new training set. The training sequence continues until, in block 1324, a local minimum has been reached.

Now that a local minimum has been reached and the corrections have been back-propagated, in block 1332, the neural network is ready.

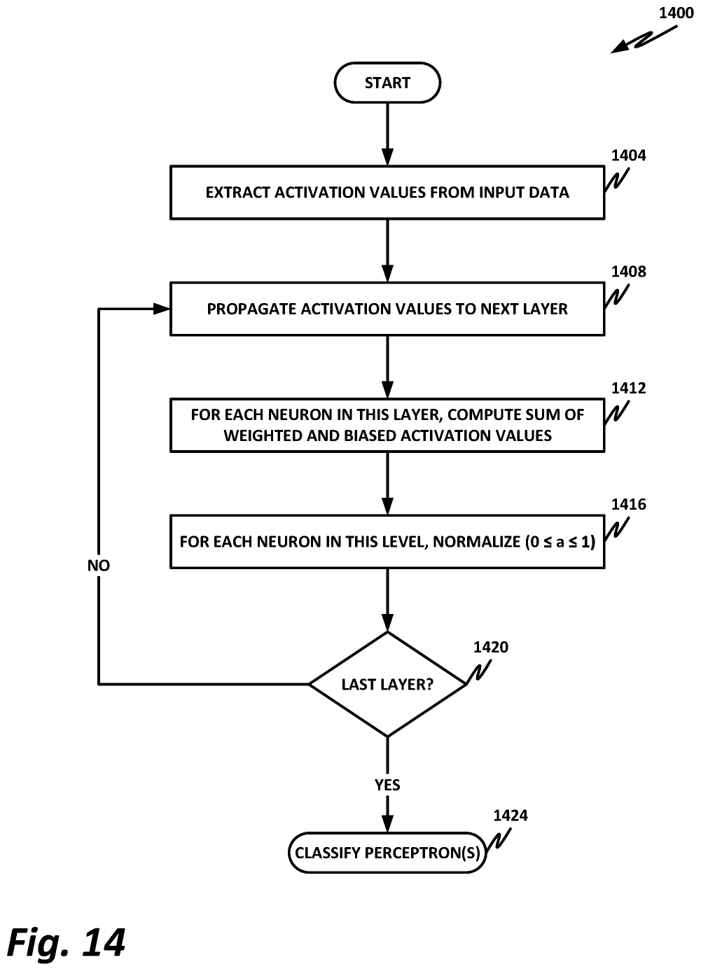

FIG. 14 is a flowchart of a method 1400. Method 1400 illustrates a method of using a neural network, such as network 1200 of FIG. 12, to classify an object.

In block 1404, the network extracts the activation values from the input data. For example, in the example of FIG. 12, each pixel in input image 1204 is assigned as an activation value to a neuron 1208 in input layer 1212.

In block 1408, the network propagates the activation values from the current layer to the next layer in the neural network. For example, after activation values have been extracted from the input image, those values may be propagated to the first hidden layer of the network.

In block 1412, for each neuron in the current layer, the neuron computes a sum of weighted and biased activation values received from each neuron in the previous layer. For example, in the illustration of FIG. 12, neuron 0 of the first hidden layer is connected to each neuron in input layer 1212. A sum of weighted values is computed from those activation values, and a bias is applied.

In block 1416, for each neuron in the current layer, the network normalizes the activation values by applying a function such as sigmoid, ReLU, or some other function.

In decision block 1420, the network determines whether it has reached the last layer in the network. If this is not the last layer, then control passes back to block 1408, where the activation values in this layer are propagated to the next layer.

Returning to decision block 1420, If the network is at the last layer, then the neurons in this layer are perceptrons that provide final output values for the object. In terminal 1424, the perceptrons are classified and used as output values.

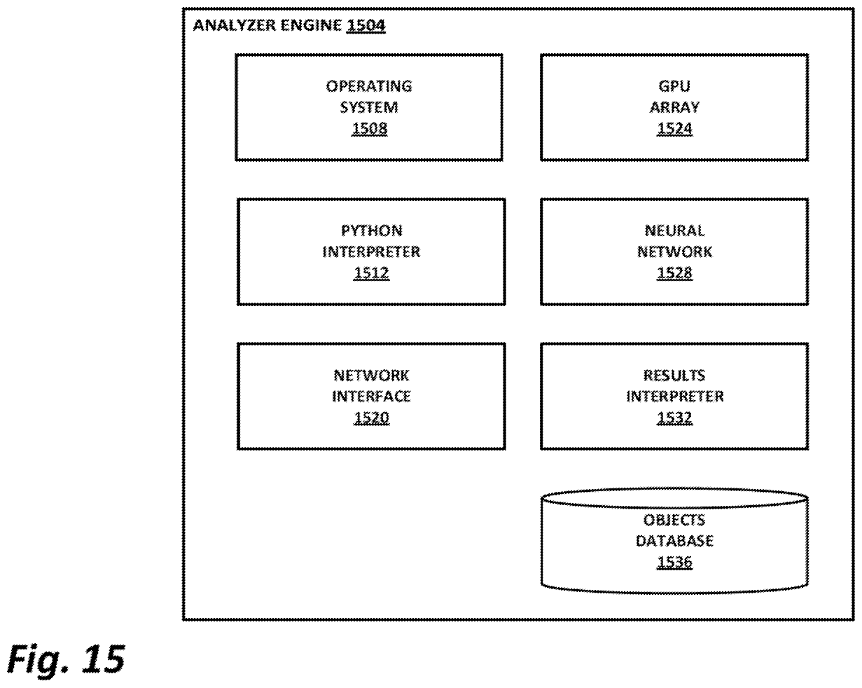

FIG. 15 is a block diagram illustrating selected elements of an analyzer engine 1504. Analyzer engine 1504 may be configured to provide analysis services, such as via a neural network. FIG. 15 illustrates a platform for providing analysis services. Analysis, such as neural analysis and other machine learning models, may be used in some embodiments to provide one or more features of the present disclosure.

Note that analyzer engine 1504 is illustrated here as a single modular object, but in some cases, different aspects of analyzer engine 1504 could be provided by separate hardware, or by separate guests (e.g., VMs or containers) on a hardware system.

Analyzer engine 1504 includes an operating system 1508. Commonly, operating system 1508 is a Linux operating system, although other operating systems, such as Microsoft Windows, Mac OS X, UNIX, or similar could be used. Analyzer engine 1504 also includes a Python interpreter 1512, which can be used to run Python programs. A Python module known as Numerical Python (NumPy) is often used for neural network analysis. Although this is a popular choice, other non-Python or non-NumPy systems could also be used. For example, the neural network could be implemented in Matrix Laboratory (MATLAB), C, C++, Fortran, R, or some other compiled or interpreted computer language.

GPU array 1524 may include an array of graphics processing units that may be used to carry out the neural network functions of neural network 1528. Note that GPU arrays are a popular choice for this kind of processing, but neural networks can also be implemented in CPUs, or in ASICs or FPGAs that are specially designed to implement the neural network.

Neural network 1528 includes the actual code for carrying out the neural network, and as mentioned above, is commonly programmed in Python.

Results interpreter 1532 may include logic separate from the neural network functions that can be used to operate on the outputs of the neural network to assign the object for particular classification, perform additional analysis, and/or provide a recommended remedial action.

Objects database 1536 may include a database of known objects and their classifications. Neural network 1528 may initially be trained on objects within objects database 1536, and as new objects are identified, objects database 1536 may be updated with the results of additional neural network analysis.

Once final results have been obtained, the results may be sent to an appropriate destination via network interface 1520.

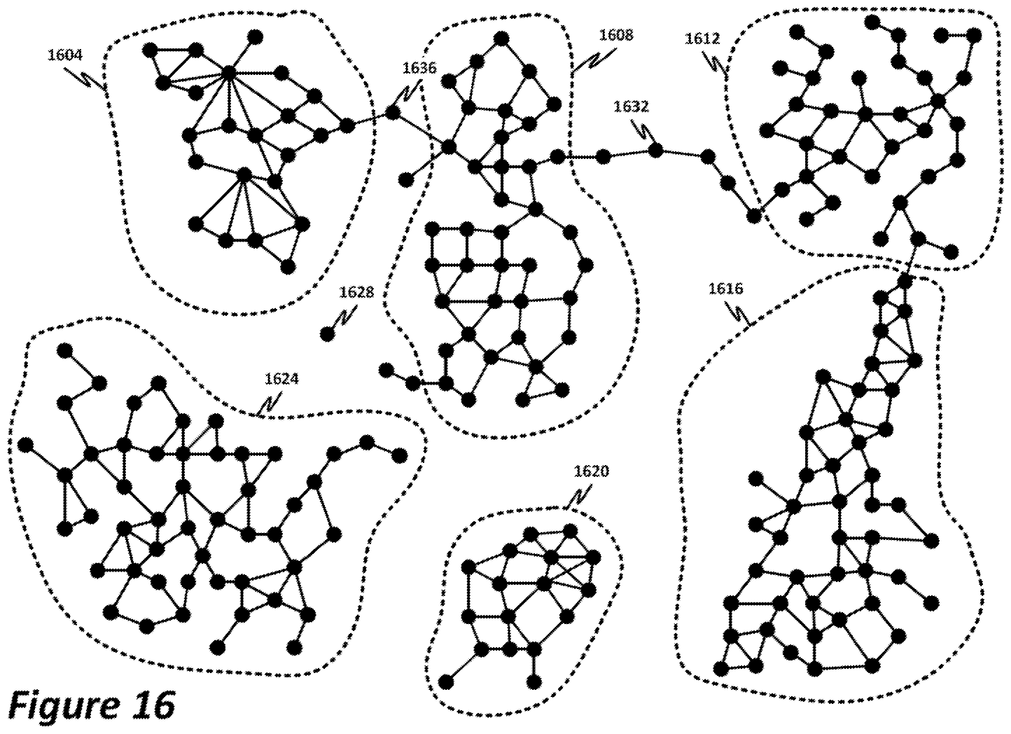

FIG. 16 is a block diagram illustration of selected elements of a clustering system. Clustering is useful in estimating the properties of an object, on the assumption that if objects cluster together based on certain properties, other properties are also likely to be similar.

Illustrative examples of known clustering algorithms include, without limitation, DBSCAN, K-means, Binary Tree, Fuzzy Clustering, Affinity Propagation, Normal Distribution, Mean Shift, Hierarchical Clustering, Spectral Clustering, and Mean Clustering.

When a system or an enterprise encounters a new, unknown object, the object may be featurized and mapped into a cluster space. If the object clusters strongly with other objects with known classifications, then at least as an initial classification, the system may assume that the object has the same classification as other objects in the cluster. If all are known to be of a class, the object may be treated as belonging to that class. If there are different classifications within the cluster, then the classification for a majority or supermajority of the known objects may be used for the new object.

In the example of FIG. 16, a group of objects (represented here as individual points) have been mapped into an object space. The objects are clustered according to their proximity to one another.

In one illustrative example (e.g., DBSCAN), mapping the objects may include extracting features from the object into a feature vector. DBSCAN is used here as an illustration of the principles of clustering. Other clustering algorithms may use different algorithms, although the concept of similarity based on proximity may, at some level, be preserved.

For a particular embodiment, the system designer selects a number of n features for the system, and extracts those n features from each sample. In this case, n may be any integer where n≥1, although as the number of features increases, so does the complexity of the system. Thus, a system designer may trade off between feature granularity and system performance, depending on the needs of an embodiment and the available compute resources.

In an illustrative clustering algorithm, each sample is mapped into an n-dimensional space, and the system computes a vector distance between each point and one or more nearest neighbors. The designer may select a distance ε, and any objects within distance ε of one another cluster together. The system designer may also select a factor minPTS, which is the minimum number of points that a point must be proximate to for the point to be considered a “core point.”

In this example, the samples have clustered into a plurality of clusters, namely cluster 1604, cluster 1608, cluster 1612, cluster 1616, cluster 1620, and cluster 1624. A small number of points are illustrated here to simplify the illustration, although in a real-world use case, the number of points may be in the hundreds, thousands, millions, or billions. The clusters and distances are not necessarily shown to scale, each point may represent some greater number of points, and each connection/proximity line may represent one or more proximity connections (e.g., each proximity line represents a connection to a point within distance ¿).

The clusters illustrated here may include a number of “core points,” which are points proximate to at least minPTS points. For example, if minPTS=4, then a sample must be proximate to at least three other points (counting itself as the fourth proximate point) to be considered a core point. Core points are important to DBSCAN and some other clustering methods because core points consistently map to the same cluster across different runs, even if the data are in a different order. A noncore point 1636 is also illustrated. This point is within distance ¿ of at least one other point, but not enough points to be considered a core point. Thus, depending on the ordering of the data, the point may cluster with either 1604 or 1608. Noncore point 1636 appears as a “bridge” between clusters 1604 and 1608.

Clusters 1612 and 1616 may be two separate clusters, or one single cluster, depending on the designer's selection of minPts. A chain of points with few connections forms a bridge between the two clusters. This illustrates the principle that the selection of minPTS may influence the number of clusters that form. A higher value for minPTS may form smaller clusters with greater similarity. A smaller value may form larger clusters with rougher similarity. The selection will depend on the needs of a particular embodiment.

Clusters 1608 and 1612 are joined by a bridge 1632 of noncore points. This bridge illustrates that some points may share some similarity, but as the cluster drifts, the overall similarity of the cluster may decrease, and at some point its predictive value may be compromised. Indeed, clusters 1604, 1608, 1612, and 1616 could form one large supercluster if minPTS is selected to be sufficiently small. Whether this supercluster would be sufficiently predictive of the properties of members of the cluster may depend on the specific use case.

In contrast, clusters 1620 and 1624 have no bridge to any other clusters, so those clusters may remain the same, regardless of the value of minPTS. However, the addition of new data to the dataset may influence later runs of the algorithm and may form bridges.

Also illustrated here in an outlier point 1628. Outlier 1628 is not similar enough to any other sample to cluster, regardless of the value of minPTS. Thus, clusters are not predictive of the properties of outlier 1628.

The foregoing outlines features of several embodiments so that those skilled in the art may better understand various aspects of the present disclosure. The foregoing detailed description sets forth examples of apparatuses, methods, and systems relating to a system and method for location management, according to one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-59. (canceled)

60. A computer-implemented method of providing location intelligence for a geospatial location, comprising:
receiving, from a plurality of location intelligence sources, a plurality of location intelligence data about the geospatial location, wherein the plurality of location intelligence data are not natively interoperable with one another;
operating a machine learning (ML) algorithm to reconcile plurality of location intelligence data into a location intelligence digest for the geospatial location; and
presenting the location intelligence digest to a human user in a human perceptible form via a human interface device (HID).

61. The method of claim 60, wherein the location intelligence sources comprise at least one geographic information system (GIS) database.

62. The method of claim 60, wherein the location intelligence sources comprise real-time sensors and/or internet of things (IoT) devices.

63. The method of claim 60, wherein the location intelligence sources comprise websites of businesses or enterprises with a physical presence near the geospatial location.

64. The method of claim 60, wherein the location intelligence sources comprise satellite imagery of the geospatial location and/or nearby locations.

65. The method of claim 60, wherein the location intelligence sources comprise third-party applications.

66. The method of claim 65, wherein the third-party applications comprises enterprise resource planning (ERP) or customer relationship management (CRM) systems.

67. The method of claim 60, wherein presenting the location intelligence digest to the human user via the HID comprises optimizing the HID for a mobile device.

68. The method of claim 60, wherein presenting the location intelligence digest to the human user via the HID comprises providing predictive analytics.

69. The method of claim 60, wherein presenting the location intelligence digest to the human user via the HID comprises providing collaboration tools for a plurality of users.

70. The method of claim 60, wherein presenting the location intelligence digest to the human user via the HID comprises providing an automatically generated report of the location intelligence digest.

71. The method of claim 60, wherein presenting the location intelligence digest to the human user via the HID comprises translating the location intelligence digest into a target language for the human user.

72. The method of claim 60, wherein presenting the location intelligence digest to the human user via the HID comprises providing the location intelligence digest as a contextual input to a chatbot, and providing an interface for the human user to interact with the chatbot.

73. The method of claim 60, further comprising providing a private cloud environment for private information specific to the human user or an enterprise that the human user is associated with, wherein the private cloud environment encrypts the private information.

74. The method of claim 60, wherein the HID comprises a map overlay.

75. One or more tangible, nontransitory computer-readable storage media having stored thereon executable instructions to provide a location intelligence orchestrator, the instructions to instruct a processor to:
receive, from a plurality of location intelligence sources, a plurality of location intelligence data about a geospatial location, wherein the plurality of location intelligence data are not natively interoperable with one another;
operate a machine learning (ML) algorithm to reconcile plurality of location intelligence data into a location intelligence digest for the geospatial location; and
present the location intelligence digest to a human user in a human perceptible form via a human interface device (HID).

76. The one or more tangible, nontransitory computer-readable storage media of claim 75, wherein the location intelligence sources comprise at least one geographic information system (GIS) database.

77. The one or more tangible, nontransitory computer-readable storage media of claim 75, wherein the location intelligence sources comprise third-party applications.

78. A location intelligence orchestrator, comprising:
a hardware platform comprising at least one processor circuit and at least one memory; and
instructions encoded within the at least one memory to instruct the at least one processor circuit to:
receive, from a plurality of location intelligence sources, a plurality of location intelligence data about a geospatial location, wherein the plurality of location intelligence data are not natively interoperable with one another;
operate a machine learning (ML) algorithm to reconcile plurality of location intelligence data into a location intelligence digest for the geospatial location; and
present the location intelligence digest to a human user in a human perceptible form via a human interface device (HID).

79. The location intelligence orchestrator of claim 78, wherein the location intelligence sources comprise at least one geographic information system (GIS) database.
